(19) United States
(12) Patent Application Publication
(10) Pub. No.: US 2026/0267497 A1
(43) Pub. Date: Sep. 10, 2026

(54) METHOD FOR DISPLAYING DYNAMIC WALLPAPER AND ELECTRONIC DEVICE

(71) Applicant: HONOR DEVICE CO., LTD., Shenzhen (CN)

(72) Inventors: Haijing Fu, Shenzhen (CN); Gaoge Zhao, Shenzhen (CN); HAO DONG, Shenzhen (CN)

(21) Appl. No.: 19/658,212

(22) Filed: Apr. 24, 2026

Related U.S. Application Data
(63) Continuation of application No. PCT/CN2025/095584, filed on May 16, 2025.

(30) Foreign Application Priority Data
Jun. 12, 2024 (CN) 202410761010.0

(51) Int. Cl. G06F 3/04847; G06F 3/04817; G06F 3/0488; G06F 3/14; H04M 1/02

(52) U.S. Cl. CPC G06F 3/04847; G06F 3/0488; G06F 3/1446; G06F 3/04817; H04M 1/0214

(57) ABSTRACT

This application relates to the terminal field, and provides a method for displaying a dynamic wallpaper and an electronic device. The method includes: responding to a first operation, and applying a first theme, where the first theme has a corresponding video resource, and the video resource includes a lock screen wallpaper and a plurality of video sections; displaying a lock screen interface after the first theme is applied, where the lock screen interface includes the lock screen wallpaper; responding to a second operation performed on the lock screen interface, and displaying a first video in the plurality of video sections; and responding to a third operation performed on the lock screen interface, and displaying a second video in the plurality of video sections, where positions of the third operation and the second operation are different, the second video is different from the first video.

### CROSS-REFERENCE TO RELATED APPLICATIONS

This application is a continuation of International Application No. PCT/CN2025/095584, filed on May 16, 2025, which claims priority to Chinese Patent Application No. 202410761010.0, filed on Jun. 12, 2024, both of which are incorporated herein by reference in their entireties.

### TECHNICAL FIELD

This application relates to the field of terminals, and specifically, to a method for displaying a dynamic wallpaper and an electronic device.

### BACKGROUND

Wallpapers on electronic devices usually reflect aesthetic needs of users. Different wallpapers can be set for different users based on interests of the users, to meet personalized needs of the users on wallpaper display effect. Currently, the electronic device may provide some static wallpapers, dynamic wallpapers, and the like for a user to select, and the user may also use a customized image such as a photo as a wallpaper.

However, for example, the electronic device is a small foldable mobile phone, and wallpaper display effect on an outer screen is not good, causing poor user experience.

### SUMMARY

This application provides a method for displaying a dynamic wallpaper and an electronic device, to implement rich dynamic-wallpaper display effect during user interaction, thereby improving user experience.

According to a first aspect, a method for displaying a dynamic wallpaper is provided. The method is applied to an electronic device, including: responding to a first operation, and applying a first theme, where the first theme has a corresponding video resource, and the video resource includes a lock screen wallpaper and a plurality of video sections;
displaying a lock screen interface after the first theme is applied, where the lock screen interface includes the lock screen wallpaper;
responding to a second operation performed on the lock screen interface, and displaying a first video in the plurality of video sections; and
responding to a third operation performed on the lock screen interface, and displaying a second video in the plurality of video sections, where positions of the third operation and the second operation are different, the second video is different from the first video, and the second video, the lock screen wallpaper, and the first video include a same target object.

For example, the target object may be a kitten shown in FIG. 12. For example, if an operation is performed on the lock screen interface, a first video section related to the kitten may be played; and if a second operation is performed on the lock screen interface, a second video section related to the same kitten may be played. The kitten has different actions in the first video section and the second video section.

In this embodiment of this application, a user performs two operations at different positions on the lock screen interface, to trigger the electronic device to play two different video sections related to a same target object, thereby implementing rich display effect and increasing interest of using the electronic device.

It should be understood that positions of the third operation and the second operation may be different, or may be the same. This is equivalent to the user performing an operation at the same position twice, but playing different videos.

With reference to the first aspect, in some implementations of the first aspect, the video resource further includes at least one hot zone and a first correspondence between the at least one hot zone and the video. After the responding to a second operation performed on the lock screen interface, the method further includes: determining that the second operation triggers falling into a first hot zone; and determining, from the video resource based on the first correspondence, the first video corresponding to the first hot zone.

It should be understood that the hot zone is a local region of a screen of the electronic device.

In this embodiment of this application, the screen of the electronic device is equivalent to including at least one hot zone. In this case, the video resource includes the at least one hot zone and the first correspondence between the at least one hot zone and the video. Therefore, when the user performs an operation on the hot zone, a video corresponding to the hot zone is determined, based on a hot zone corresponding to the user operation, for playing. In other words, the user may play, by triggering the hot zone, the video corresponding to the hot zone.

With reference to the first aspect, in some implementations of the first aspect, the determining that the second operation triggers falling into a first hot zone includes: determining first coordinates corresponding to the second operation; and determining that the first coordinates belong to a coordinate range of the first hot zone, and determining that the second operation triggers falling into the first hot zone.

In this embodiment of this application, a hot zone triggered by the user may be determined by determining a coordinate range, including coordinates of a user operation, of the hot zone.

With reference to the first aspect, in some implementations of the first aspect, after the responding to a third operation performed on the lock screen, the method further includes: determining that the third operation triggers falling into a second hot zone; and determining, from the video resource based on the first correspondence, the second video corresponding to the second hot zone, where the second hot zone is the same as or different from the first hot zone.

It should be understood that the first hot zone and the second hot zone may be the same. This indicates that the second operation and the third operation are performed at different positions in the same hot zone. A different video section is played each time. The first hot zone and the second hot zone are different. This indicates that the second operation and the third operation are performed at different hot zones. A different video section is played each time.

In this embodiment of this application, for a same hot zone, the user may perform an operation twice to play different videos. In this way, it is equivalent to a one-to-many correspondence between one hot zone and two videos. For two different hot zones, the user may also perform an operation twice to play different videos. In this way, it is equivalent to a one-to-one correspondence between two hot zones and two videos.

With reference to the first aspect, in some implementations of the first aspect, one or more local regions of the target object included in the lock screen wallpaper correspond to one or more hot zones.

In this embodiment of this application, the target object may be a cat shown in FIG. 13. As shown in FIG. 13, one local region of the cat may correspond to one or more hot zones, or a plurality of local regions may correspond to one or more hot zones.

With reference to the first aspect, in some implementations of the first aspect, the target object included in the lock screen wallpaper is a grid image, and each grid in the grid image corresponds to one hot zone.

In this embodiment of this application, the target object may be a nine-square grid image shown in FIG. 14. As shown in FIG. 14, one local region of the cat may correspond to one or more hot zones, or a plurality of local regions may correspond to one or more hot zones.

With reference to the first aspect, in some implementations of the first aspect, the first correspondence includes at least a hot zone identifier, a first video section identifier, and a correspondence between the hot zone identifier and the first video section identifier. The hot zone identifier indicates the hot zone. The first video section identifier indicates some videos of the plurality of video sections.

For example, the first correspondence is a relationship shown in Table 1.

In this embodiment of this application, by querying the first correspondence shown in Table 1, the corresponding first video section identifier may be found based on the hot zone identifier of the hot zone, and the associated video is further determined based on the first video section identifier.

With reference to the first aspect, in some implementations of the first aspect, after the displaying a lock screen interface, the method further includes: responding to a first action of the electronic device, and displaying a third video in the plurality of video sections; and responding to a second action of the electronic device, and displaying a fourth video in the plurality of video sections, where the first action is different from the second action, the fourth video is different from the third video, and both the fourth video and the third video include the target object.

An action of the electronic device may include: tilting to the left, tilting to the right, shaking up to the left, shaking up to the right, shaking down to the left, shaking down to the right, moving forward in a direction perpendicular to a screen, or moving backward in a direction perpendicular to a screen.

The first action and the second action each are any action of the electronic device.

For example, the target object may be a dial shown in FIG. 16, a bunch of bubbles shown in FIG. 17, or a polar bear shown in FIG. 18.

In this embodiment of this application, two actions are performed on the electronic device, to trigger the electronic device to play two different video sections related to a same target object, thereby implementing rich display effect and increasing interest of using the electronic device.

With reference to the first aspect, in some implementations of the first aspect, the video resource further includes at least one gravity sensing type and a second correspondence between the at least one gravity sensing type and the video. After the responding to a first action of the electronic device, the method further includes: determining that a gravity sensing type corresponding to the first action of the electronic device is a first gravity sensing type; and determining, from the video resource based on the second correspondence, the third video corresponding to the first gravity sensing type.

In this embodiment of this application, a gravity sensing type is in a one-to-one correspondence with an action of the electronic device. The gravity sensing type may include:
tilting to the left, tilting to the right, shaking up to the left, shaking up to the right, shaking down to the left, shaking down to the right, moving forward in a direction perpendicular to a screen, or moving backward in a direction perpendicular to a screen.

In this embodiment of this application, the video resource includes the at least one gravity sensing type and the second correspondence between the at least one gravity sensing type and the video. When the electronic device performs an action, a video corresponding to the gravity sensing type may be determined, based on the gravity sensing type corresponding to the action of the electronic device, for playing. In other words, the action of the electronic device may implement playing of the video corresponding to the corresponding gravity sensing.

With reference to the first aspect, in some implementations of the first aspect, the electronic device includes a sensor. The determining that a gravity sensing type corresponding to the first action of the electronic device is a first gravity sensing type includes: determining first sensor data corresponding to the first action of the electronic device; and determining that the first sensor data belongs to a sensor data range of the first gravity sensing type, and determining that the gravity sensing type corresponding to the first action of the electronic device is the first gravity sensing type.

In this embodiment of this application, the sensor data range including the sensor data corresponding to the action of the electronic device is determined, to determine the gravity sensing type corresponding to the electronic device.

With reference to the first aspect, in some implementations of the first aspect, the gravity sensing type includes: at least one of tilting to the left, tilting to the right, shaking up to the left, shaking up to the right, shaking down to the left, shaking down to the right, moving forward in a direction perpendicular to a screen, or moving backward in a direction perpendicular to a screen includes at least one.

With reference to the first aspect, in some implementations of the first aspect, when the first operation is received in a process of displaying the third video on the lock screen interface, the method further includes: continuing displaying the third video, and skipping displaying the first video; or stopping displaying the third video, and switching to display the first video.

In this embodiment of this application, when an operation performed by the user on the lock screen interface is received in a process of playing a corresponding video based on the action of the electronic device, the electronic device may choose not to interrupt the current video and continue playing the currently played video according to a preset playing rule, or may choose to interrupt the current video and play a video determined based on the user operation.

With reference to the first aspect, in some implementations of the first aspect, when the electronic device performs the first action in a process of displaying the first video on the lock screen interface, the method further includes: continuing displaying the first video, and skipping displaying the third video; or stopping displaying the first video, and switching to display the third video.

In this embodiment of this application, when an operation performed by the user on the lock screen interface is received and the electronic device performs action switching in a process of playing a corresponding video, the electronic device may choose not to interrupt the current video and continue playing the currently played video according to a preset playing rule, or may choose to interrupt the current video and play a video determined based on the action of the electronic device.

With reference to the first aspect, in some implementations of the first aspect, when the first operation is received and the electronic device performs an action, the method further includes: selecting, based on a preset display priority, a video from the first video and the third video, and displaying the video on the lock screen interface.

In this embodiment of this application, when an operation performed by the user on the lock screen interface is received and the electronic device simultaneously generates an action, any one of two videos corresponding to the operation and the action may be selected based on a preset playing priority for playing.

With reference to the first aspect, in some implementations of the first aspect, the second correspondence includes at least a gravity sensing type, a second video section identifier, and a correspondence between the gravity sensing type and the second video section identifier; and the second video section identifier indicates some videos of the plurality of video sections.

For example, the second correspondence is a relationship shown in Table 2.

In this embodiment of this application, by querying the second correspondence shown in Table 2, the corresponding second video section identifier may be found based on the gravity sensing type corresponding to the action of the electronic device, and the associated video is further determined based on the second video section identifier.

With reference to the first aspect, in some implementations of the first aspect, the method further includes: a display order of the first video and the second video is the same as an order in which the first video and the second video are set in the video resource, or a display order of the first video and the second video is randomly displaying.

In this embodiment of this application, the positions of the third operation and the second operation may be different or the same. In this case, when the positions of the third operation and the second operation are different or the same, the display order of the first video and the second video is the same as the order in which the first video and the second video are set in the video resource, or the display order of the first video and the second video is randomly displaying.

With reference to the first aspect, in some implementations of the first aspect, when the positions of the third operation and the second operation are different or the same, and the second hot zone is the same as the first hot zone, the method further includes: a display order of the first video and the second video is the same as an order in which the first video and the second video are set in the video resource, or a display order of the first video and the second video is randomly displaying.

In this embodiment of this application, when no hot zone is configured, the user performs two operations at different positions on the lock screen interface, or performs two operations at a same position on the lock screen interface, to trigger the electronic device to play two different video sections related to a same target object. The two video sections may be played sequentially or randomly.

When a hot zone is configured, the user performs two operations at different positions or at a same position for a same hot zone on the lock screen interface, to trigger the electronic device to play two different video sections related to a same target object. The two video sections may be played sequentially or randomly. In this case, regardless of whether the positions are the same, it is equivalent to the two operations triggering the same hot zone. There is a correspondence between the hot zone and the two video sections.

With reference to the first aspect, in some implementations of the first aspect, the responding to a third operation performed on the lock screen interface, and playing a second video in the plurality of video sections includes: responding to the third operation performed on the lock screen interface, and playing a second video in the plurality of video sections; and continuing to play a fifth video in the plurality of video sections after playing of the second video is completed.

The fifth video is different from the first video and the second video. The fifth video includes the target object.

In this embodiment of this application, regardless of whether a hot zone is configured, an operation is triggered for the lock screen interface, or an operation is triggered for the hot zone, to play a plurality of video sections including a same target object.

With reference to the first aspect, in some implementations of the first aspect, a playing order of the second video and the fifth video is the same as an order in which the second video and the fifth video are set in the video resource, or a playing order of the second video and the fifth video is randomly playing.

In this embodiment of this application, regardless of whether a hot zone is configured, an operation is triggered for the lock screen interface, or an operation is triggered for the hot zone, to play a plurality of video sections including a same target object. In this case, the plurality of video sections may be played sequentially or randomly.

With reference to the first aspect, in some implementations of the first aspect, the first operation, the second operation, and the third operation each are a tap operation.

In this embodiment of this application, an operation triggered by the user on the lock screen interface is a tap operation.

With reference to the first aspect, in some implementations of the first aspect, the plurality of video sections belong to a same file, and a last frame of a previous video section included in two adjacent video sections is adjacent to a first frame of a current video section.

In this embodiment of this application, the plurality of video sections are different video sections in one video, and the plurality of video sections are sequentially connected end to end. The file including the plurality of video sections may be in a mov format.

With reference to the first aspect, in some implementations of the first aspect, the lock screen interface includes: an interface displayed by the electronic device when the screen is turned on and locked, and an interface displayed when a home screen is not displayed after the screen is turned on and unlocked.

In this embodiment of this application, the lock screen interface may be an interface shown in (b) in FIG. 4 and (c) in FIG. 4.

With reference to the first aspect, in some implementations of the first aspect, the electronic device is a foldable screen, the screen of the electronic device is an outer screen of the foldable screen, and the foregoing display step is performed on the outer screen of the foldable screen.

In this embodiment of this application, the method for displaying a dynamic wallpaper may be applied to the outer screen of the small foldable mobile phone, to improve user interaction experience.

According to a second aspect, an electronic device is provided. The electronic device includes one or more processors and a memory. The memory is coupled to the one or more processors. The memory is configured to store computer program code. The computer program code includes computer instructions. The one or more processors invoke the computer instructions to enable the electronic device to execute: responding to a first operation, and applying a first theme, where the first theme has a corresponding video resource, and the video resource includes a lock screen wallpaper and a plurality of video sections; displaying a lock screen interface after the first theme is applied, where the lock screen interface includes the lock screen wallpaper; responding to a second operation performed on the lock screen interface, and playing a first video in the plurality of video sections; and responding to a third operation performed on the lock screen interface, and playing a second video in the plurality of video sections, where positions of the third operation and the second operation are different, the second video is different from the first video, and the second video, the lock screen wallpaper, and the first video include a same target object. This application implements rich dynamic-wallpaper display effect during user interaction, thereby improving user experience.

According to a third aspect, an electronic device is provided, including a module/unit configured to perform the method for displaying a dynamic wallpaper according to the first aspect or any one of the implementations of the first aspect.

According to a fourth aspect, an electronic device is provided. The electronic device includes one or more processors and a memory. The memory is coupled to the one or more processors. The memory is configured to store computer program code. The computer program code includes computer instructions. The one or more processors invoke the computer instructions to enable the electronic device to perform the method for displaying a dynamic wallpaper according to the first aspect or any one of the implementations of the first aspect.

According to a fifth aspect, a chip system is provided, where the chip system is applied to an electronic device, the chip system includes one or more processors, and the processor is configured to invoke computer instructions to enable the electronic device to perform the method for displaying a dynamic wallpaper according to the first aspect or any implementation of the first aspect.

According to a sixth aspect, a computer-readable storage medium is provided, where the computer-readable storage medium stores computer program code, and when the computer program code is executed by an electronic device, the electronic device is enabled to perform the method for displaying a dynamic wallpaper according to the first aspect or any one of the implementations of the first aspect.

According to a seventh aspect, a computer program product is provided, where the computer program product stores computer program code, and when the computer program code is executed by an electronic device, the electronic device is enabled to perform the method for displaying a dynamic wallpaper according to the first aspect or any one of the implementations of the first aspect.

### BRIEF DESCRIPTION OF DRAWINGS

FIG. 1 is a diagram of a hardware system of an electronic device to which this application is applicable;

FIG. 2 is a diagram of a small foldable mobile phone;

FIG. 3 is a diagram of a display region of an outer screen of a small foldable mobile phone according to an embodiment of this application;

FIG. 4 shows displayed interfaces related to an outer screen of a small foldable mobile phone according to an embodiment of this application;

FIG. 5 is a diagram of a software system of an electronic device to which this application is applicable;

FIG. 6 is a diagram of a structure of another software system according to an embodiment of this application;

FIG. 7A and FIG. 7B are a schematic flowchart of a method for displaying a dynamic wallpaper according to an embodiment of this application;

FIG. 8A and FIG. 8B are a schematic flowchart of another method for displaying a dynamic wallpaper according to an embodiment of this application;

FIG. 9 is a diagram of related interfaces for playing a video section in response to a tap operation when a hot zone and gravity sensing are not configured;

FIG. 10 is an example of video sections played in FIG. 9;

FIG. 11A and FIG. 11B are a schematic flowchart of still another method for displaying a dynamic wallpaper according to an embodiment of this application;

FIG. 12 is a diagram of related interfaces for playing a video section in response to a tap operation when a hot zone is configured and gravity sensing is not configured;

FIG. 13 is a diagram of a correspondence between hot zones and video sections;

FIG. 14 is another diagram of a correspondence between hot zones and video sections;

FIG. 15A and FIG. 15B are a schematic flowchart of a method for displaying a dynamic wallpaper according to an embodiment of this application;

FIG. 16 is a diagram of related interfaces for playing a video section in response to a tilt operation when a hot zone is not configured and gravity sensing is configured;

FIG. 17 is a diagram of related interfaces for playing a video section in response to a shake operation when a hot zone is not configured and gravity sensing is configured;

FIG. 18 is a diagram of related interfaces for playing a video section in response to a perpendicular move operation when a hot zone is not configured and gravity sensing is configured;

FIG. 19A(1) to FIG. 19E(2) are interaction diagrams of a method for displaying a dynamic wallpaper according to an embodiment of this application;

FIG. 20 and FIG. 21 are diagrams of related interfaces of setting to stay lock-screen after an outer screen is unlocked according to an embodiment of this application;

FIG. 22A, FIG. 22B, FIG. 22C, FIG. 22D, FIG. 23A, and FIG. 23B are diagrams of related interfaces of switching a lock screen theme according to an embodiment of this application;

FIG. 24A, FIG. 24B, and FIG. 24C show other displayed interfaces related to an outer screen of a small foldable mobile phone according to an embodiment of this application; and

FIG. 25 is a schematic flowchart of a method for displaying a dynamic wallpaper according to an embodiment of this application.

### DESCRIPTION OF EMBODIMENTS

In embodiments of this application, the following terms “first”, “second”, and the like are merely used for description, and shall not be understood as an indication or implication of relative importance or an implicit indication of a quantity of indicated technical features. Therefore, features defined by using “first” and “second” may explicitly or implicitly include one or more such features. In the descriptions of embodiments, unless otherwise stated, “a plurality of” means two or more.

It should be further understood that the term “include” (also referred to as “includes”, “including”, “comprises”, and/or “comprising”), when used in this specification, specifies the presence of stated features, integers, steps, operations, elements, and/or components, but does not preclude the presence or addition of one or more other features, integers, steps, operations, elements, components, and/or groups thereof.

For ease of understanding of embodiments of this application, related nouns involved in embodiments of this application are first briefly described below.

### 1. System Application and Third-Party Application:

The system application is an application that is directly provided by an operating system of the electronic device and that is used to implement a specific function. The third-party application is an application program that is obtained by an electronic device through the Internet and that is provided by another developer for implementing a specific function. In embodiments of this application, an application providing a user interface may be a system application, or may be a third-party application.

### 2. Widget

The widget is an information carrier, and intuitively, and fast and conveniently provides important or user-related information in a condensed form for displaying information. The widget may be displayed on a displayed interface of the electronic device, for example, on a home screen or a lock screen interface of the electronic device. The widget may include weather information, exercise information, health information, date, a clock indicator, an art font, and the like.

For example, the clock indicator may be displayed on both the lock screen interface and the home screen. The clock indicator is used to display time information. When the clock indicator is displayed on the home screen, after a user taps the clock indicator, the electronic device can switch to displaying a main interface corresponding to a clock application. Certainly, one widget may provide information related to one application, or may integrate information related to a plurality of applications. For another example, a widget integrating date and the clock indicator may be displayed on the lock screen interface; and a widget integrating date, the clock indicator, and weather may be displayed on the home screen.

The widget may be displayed in a card form, displayed in a pure text form, or may be displayed in another form. For example, the clock indicator may be displayed in a card form, or displayed in a pure text form, or may be displayed in a clock face form. This is not limited in embodiments of this application.

Content displayed in the widget includes but is not limited to a text, a number, an image, music, a video, and the like. Content displayed in the widget is not limited in embodiments of this application.

### 3. Wallpaper

(1) The wallpaper may include an always-on display wallpaper, a lock screen wallpaper, and a home screen wallpaper according to wallpaper application scenarios. The always-on display wallpaper is a wallpaper applied on an always-on display interface, the lock screen wallpaper is a wallpaper applied on a lock screen interface, and the home screen wallpaper is a wallpaper applied on a home screen.

Always-on display (always on display, AOD) may be understood as a low-power display state during screen-off. Generally, when the user turns off a power button, the AOD may enter a doze (DOZE) state, and display an AOD animation that may also be referred to as a video. When the user does not trigger a display for a period of time, the AOD may be hidden.

This embodiment of this application mainly relates to a lock screen wallpaper on a lock screen interface of an application.

(2) According to visual effect of the wallpaper, the wallpaper may include a flat wallpaper and a depth-of-field wallpaper. The flat wallpaper may also be referred to as a two-dimensional (2Dimension, 2D) wallpaper, and the depth-of-field wallpaper may also be referred to as a stereoscopic or three-dimensional (3Dimension, 3D) wallpaper. Compared with the flat wallpaper, the depth-of-field wallpaper may include a foreground object and a background object, and the foreground object and the background object may make an image three-dimensional and vivid, to bring more cool visual experience to the user. When the depth-of-field wallpaper is applied to the lock screen interface, the foreground object is an object or a layer that is in front of a main body and that is relatively close on the lock screen interface, for example, a person or a layer at which a person is located. The background object is an object or a layer that is behind a main body and that is relatively distant on the lock screen interface, for example, a tree, a building, or a layer at which a tree and/or a building are/is located.

(3) According to motion effect of the wallpaper, the wallpaper may be divided into a static wallpaper and a dynamic wallpaper. The static wallpaper is a static image, and the dynamic wallpaper is a dynamic video, a dynamic video frame interval, or an animation.

This embodiment of this application mainly relates to the dynamic wallpaper.

### 4. Hot Zone

The hot zone is a touch region of a fixed shape and size on a screen.

The above is a brief introduction to the nouns involved in embodiments of this application. Details are not described below.

The following describes a method for displaying a dynamic wallpaper and an electronic device provided in embodiments of this application with reference to the accompanying drawings.

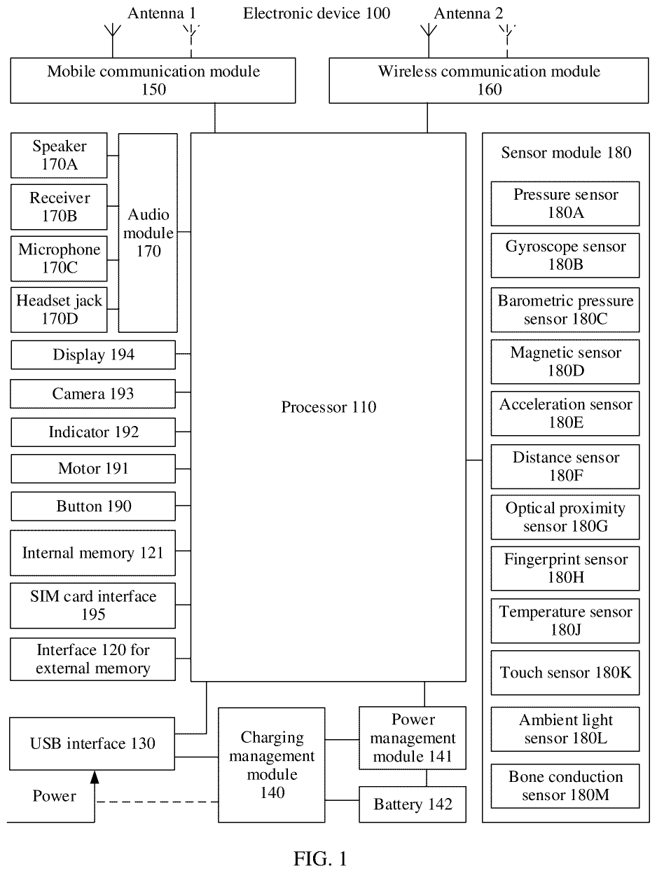

FIG. 1 shows a hardware system of an electronic device to which this application is applicable.

The electronic device 100 may be a mobile phone, a smart screen, a tablet computer, a wearable electronic device, an in-vehicle electronic device, an augmented reality (augmented reality, AR) device, a virtual reality (virtual reality, VR) device, a notebook computer, an ultra-mobile personal computer (ultra-mobile personal computer, UMPC), a netbook, a personal digital assistant (personal digital assistant, PDA), a projector, or the like. A specific type of the electronic device 100 is not limited in this embodiment of this application. For example, the electronic device 100 is a foldable mobile phone.

The electronic device 100 may include a processor 110, an interface 120 for external memory, an internal memory 121, a universal serial bus (universal serial bus, USB) interface 130, a charging management module 140, a power management module 141, a battery 142, an antenna 1, an antenna 2, a mobile communication module 150, a wireless communication module 160, an audio module 170, a speaker 170A, a receiver 170B, a microphone 170C, a headset jack 170D, a sensor module 180, a button 190, a motor 191, an indicator 192, a camera 193, a display 194, a subscriber identity module (subscriber identification module, SIM) card interface 195, and the like. The sensor module 180 may include a pressure sensor 180A, a gyroscope sensor 180B, a barometric pressure sensor 180C, a magnetic sensor 180D, an acceleration sensor 180E, a distance sensor 180F, an optical proximity sensor 180G, a fingerprint sensor 180H, a temperature sensor 180J, a touch sensor 180K, an ambient light sensor 180L, a bone conduction sensor 180M, and the like.

It should be noted that the structure shown in FIG. 1 does not constitute any specific limitation on the electronic device 100. In some other embodiments of this application, the electronic device 100 may include more or fewer components than those shown in FIG. 1, or the electronic device 100 may include a combination of some components in those shown in FIG. 1, or the electronic device 100 may include sub-components of some components in those shown in FIG. 1. The components shown in FIG. 1 may be implemented by using hardware, software, or a combination of software and hardware.

The processor 110 may include one or more processing units. For example, the processor 110 may include at least one of the following processing units: an application processor (application processor, AP), a modem processor, a graphics processing unit (graphics processing unit, GPU), an image signal processor (image signal processor, ISP), a controller, a video codec, a digital signal processor (digital signal processor, DSP), a baseband processor, and a neural-network processing unit (neural-network processing unit, NPU). Different processing units may be separate components, or may be integrated components. The controller may generate an operation control signal based on instruction operation code and a timing signal, to complete control of instruction fetching and instruction execution.

The processor 110 may be further provided with a memory. The memory is configured to store instructions and data. In some embodiments, the memory of the processor 110 is a cache. The memory may store instructions or data that is just used or is cyclically used by the processor 110. If the processor 110 needs to use the instructions or the data again, the processor may directly invoke the instructions or the data from the memory. This avoids repeated access, reduces a waiting time of the processor 110, and therefore improves system efficiency.

In some embodiments, the processor 110 may include one or more interfaces. For example, the processor 110 may include at least one of the following interfaces: an inter-integrated circuit (inter-integrated circuit, I2C) interface, an inter-integrated circuit sound (inter-integrated circuit sound, I2S) interface, a pulse code modulation (pulse code modulation, PCM) interface, a universal asynchronous receiver/transmitter (universal asynchronous receiver/transmitter, UART) interface, a mobile industry processor interface (mobile industry processor interface, MIPI), a general-purpose input/output (general-purpose input/output, GPIO) interface, a SIM card interface, and a USB interface.

For example, in this embodiment of this application, the processor 110 may be configured to perform a method for displaying a dynamic wallpaper according to an embodiment of this application, for example, responding to a first operation, and applying a first theme, where the first theme has a corresponding video resource, and the video resource includes a lock screen wallpaper and a plurality of video sections; displaying a lock screen interface after the first theme is applied, where the lock screen interface includes the lock screen wallpaper; responding to a second operation performed on the lock screen interface, and playing a first video in the plurality of video sections; and responding to a third operation performed on the lock screen interface, and playing a second video in the plurality of video sections, where positions of the third operation and the second operation are different, the second video is different from the first video, and the second video, the lock screen wallpaper, and the first video include a same target object.

A connection relationship among modules shown in FIG. 1 is merely an example for description, and constitutes no limitation on the connection relationship among the modules of the electronic device 100. Optionally, modules of the electronic device 100 may alternatively use a combination of a plurality of connection manners in the foregoing embodiment.

A wireless communication function of the electronic device 100 may be implemented by using a device such as the antenna 1, the antenna 2, the mobile communication module 150, the wireless communication module 160, the modem processor, the baseband processor, and the like.

The antenna 1 and the antenna 2 are configured to transmit and receive electromagnetic wave signals. Each antenna in the electronic device 100 may be configured to cover one or more communication frequency bands. Different antennas may be further reused to improve antenna utilization. For example, the antenna 1 may be reused as a diversity antenna of a wireless local area network. In some other embodiments, the antennas may be used in combination with a tuning switch.

The electronic device 100 may implement a display function by using the GPU, the display 194, and the application processor. The GPU is a microprocessor for image processing, and connects the display 194 and the application processor. The GPU is configured to perform mathematical and geometric computing for graphics rendering. The processor 110 may include one or more GPUs that execute program instructions to generate or change display information.

The display 194 may be configured to display an image or a video.

Optionally, the display 194 may be configured to display the image or the video. The display 194 includes a display panel. The display panel may use a liquid crystal display (liquid crystal display, LCD), an organic light-emitting diode (organic light-emitting diode, OLED), an active-matrix organic light-emitting diode (active-matrix organic light-emitting diode, AMOLED), a flex light-emitting diode (flex light-emitting diode, FLED), a mini light-emitting diode (mini light-emitting diode, Mini LED), a micro light-emitting diode (micro light-emitting diode, Micro LED), a micro OLED (Micro OLED), or a quantum dot light emitting diode (quantum dot light emitting diodes, QLED). In some embodiments, the electronic device 100 may include 1 or N displays 194, where N is a positive integer greater than 1.

For example, in this embodiment of this application, the display 194 may display a lock screen wallpaper and a home screen wallpaper. The lock screen wallpaper displayed on the display may be a flat wallpaper, or may be a depth-of-field wallpaper.

The electronic device 100 may implement a shooting function by using the ISP, the camera 193, the video codec, the GPU, the display 194, the application processor, and the like.

The ISP is configured to process data fed back by the camera 193. For example, during shooting, a shutter is enabled. Light is sent to a photosensitive element of the camera through a camera, and an optical signal is converted into an electrical signal. The photosensitive element of the camera sends the electrical signal to the ISP for processing, and therefore, the electrical signal is converted into an image visible to a naked eye. The ISP may perform algorithm optimization on noise, brightness, and a color of an image, and the ISP may further optimize parameters such as exposure and a color temperature of a shooting scene. In some embodiments, the ISP may be disposed in the camera 193.

The camera 193 (which may also be referred to as a lens) is configured to capture a still image or a video, and may be enabled through triggering by using an application instruction, to implement a shooting function, for example, obtaining an image of any scene through shooting. The camera may include parts such as an imaging lens, a light filter, and an image sensor. Light emitted or reflected by an object enters the imaging lens, passes through the light filter, and finally converges on the image sensor. The imaging lens is mainly configured to perform converging and imaging on light emitted or reflected by all objects (which may also be referred to as a to-be-photographed scenario or a target scenario, or may be understood as a scenario image expected to be photographed by the user) in a camera angle. The filter is mainly configured to filter out excess light waves (for example, light waves other than visible light, such as infrared) in light. The image sensor may be a charge coupled device (charge coupled device, CCD) or a complementary metal-oxide-semiconductor (complementary metal-oxide-semiconductor, CMOS) phototransistor. The image sensor is mainly configured to perform photoelectric conversion on a received optical signal to convert the received optical signal into an electrical signal, and then send the electrical signal to the ISP to convert the electrical signal into a digital image signal. The ISP outputs the digital image signal to the DSP for processing. The DSP converts the digital image signal into an image signal in a standard format, for example, RGB or YUV.

For example, the digital signal processor is configured to process a digital signal, and can process another digital signal in addition to the digital image signal. For example, when the electronic device 100 selects a frequency, the digital signal processor is configured to perform Fourier transformation and the like on frequency energy.

For example, the video codec is configured to compress or decompress a digital video. The electronic device 100 may support one or more types of video codecs. In this way, the electronic device 100 may play or record videos in a plurality of encoding formats, for example, moving picture experts group (moving picture experts group, MPEG) 1, MPEG 2, MPEG 3, MPEG 4, or the like.

For example, the gyroscope sensor 180B may be configured to determine a motion posture of the electronic device 100. In some embodiments, angular velocities of the electronic device 100 around three axes (that is, x, y, and z axes) may be determined through the gyroscope sensor 180B. The gyroscope sensor 180B may be configured to implement image stabilization during shooting. For example, when the shutter is pressed, the gyroscope sensor 180B detects a jittering angle of the electronic device 100, obtains, through calculation based on the angle, a distance for which a lens module needs to compensate, and allows the lens to cancel the jitter of the electronic device 100 through reverse motion, to implement image stabilization. The gyroscope sensor 180B may be further used in scenarios such as navigation and a motion sensing game.

For example, the acceleration sensor 180E may detect magnitudes of acceleration of the electronic device 100 in all directions (generally x axis, y axis, and z axis), and may detect a magnitude and a direction of gravity when the electronic device 100 is still. The acceleration sensor 180E may be further configured to recognize poses of the electronic device 100. The poses are used as input parameters for landscape and portrait mode switchover, a pedometer, and other applications.

For example, the distance sensor 180F is configured to measure a distance. The electronic device 100 may measure a distance in an infrared manner or a laser manner. In some embodiments, for example, in a shooting scenario, the electronic device 100 may measure a distance through the distance sensor 180F, to implement quick focusing.

For example, the ambient light sensor 180L is configured to sense ambient light brightness. The electronic device 100 may adaptively adjust luminance of the display 194 according to the perceived ambient light luminance. The ambient light sensor 180L may also be configured to automatically adjust white balance during shooting. The ambient light sensor 180L may also cooperate with the optical proximity sensor 180G to detect whether the electronic device 100 is in a pocket, to avoid an accidental touch.

For example, the fingerprint sensor 180H is configured to collect a fingerprint. The electronic device 100 may implement functions such as unlocking, accessing an application lock, shooting, and receiving a call by using features of the collected fingerprint.

For example, the touch sensor 180K is also referred to as a touch component. The touch sensor 180K may be disposed on the display 194. The touch sensor 180K and the display 194 form a touchscreen. The touchscreen is also referred to as a touch control screen. The touch sensor 180K is configured to detect a touch operation on or near the touch sensor 180K. The touch sensor 180K may transfer the detected touch operation to the application processor to determine a type of a touch event. Visual output related to the touch operation may be provided via the display 194. In some other embodiments, the touch sensor 180K may alternatively be disposed on a surface of the electronic device 100 and disposed at a position different from that of the display 194.

The hardware system of the electronic device 100 is described in detail above.

The electronic device having the foregoing hardware system is used as an example. The electronic device may be a foldable device. Specifically, the foldable device may be an inward folding device, or may be an outward folding device, or may be another type of multi-fold device (for example, a z-shaped foldable device). The inward folding device may include two screens. One screen is a foldable screen. When the device is in an unfolded state, the foldable screen is used for display. When the device is in a folded state, the other screen is used for display. The outward folding device may include one foldable screen. When the device is in an unfolded state, the entire screen is used for display. When the device is in a folded state, a part of the screen is used for display.

The foldable device may be a vertically folding device, or may be a horizontally folding device. A folding hinge direction of the vertically folding device is a vertical direction with respect to the device, and a folding hinge direction of the horizontally folding device is a horizontal direction with respect to the device. A specific structure of the foldable screen may be set according to needs. This is not limited in embodiments of this application.

In embodiments of this application, a small inward folding mobile phone is used as an example. A flexible display that can be folded inward may be referred to as a first display. In addition, on the other side opposite to the first display, the small foldable mobile phone further includes a second display.

Embodiments provided by this application may be applied to an inward folding device or an outward folding device; may be applied to a vertically folding device or a horizontally folding device; and may be applied to any screen of a foldable device. This is not limited in this application. The following embodiments are described by using an example in which a second display (outer screen) applied to an inward folding device or a horizontally folding device.

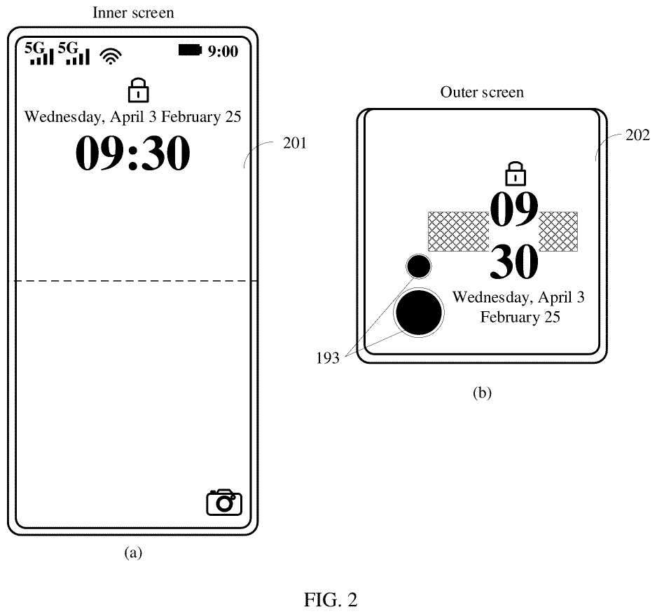

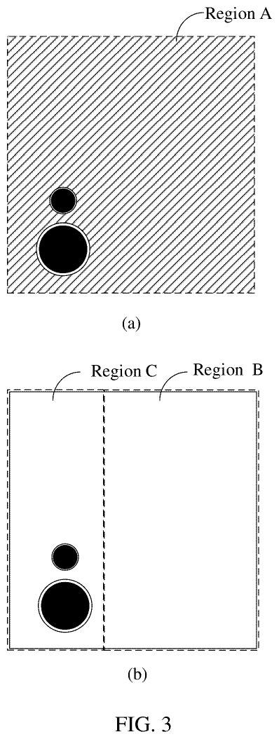

For example, FIG. 2 is a diagram of a small foldable mobile phone.

As shown in (a) in FIG. 2, the small foldable mobile phone is in an unfolded state, and a first display 201 is unfolded along a horizontal folding axis. The first display 201 may also be referred to as an inner screen. A full-screen region or a local region of the inner screen may be used for display. In addition, as shown in (b) in FIG. 2, the small foldable mobile phone is in a folded state, and the first display 201 is folded along the horizontal folding axis. On a side opposite to the first display 201, the small foldable mobile phone further includes a second display 202. The second display 202 may be referred to as an outer screen. A full-screen region or a local region of the outer screen may be used for display.

As shown in FIG. 2, the inner screen or the outer screen may be used to display a lock screen interface when being not unlocked, and may be used to display a home screen when being successfully unlocked.

Optionally, a size of the second display is less than or equal to a half of a size of the inner screen.

Optionally, when the camera 193 is not an under display camera, a display region corresponding to the second display may not include a region in which the camera is located; and when the camera 193 is an under display camera, a display region corresponding to the second display may include a region corresponding to the under display camera.

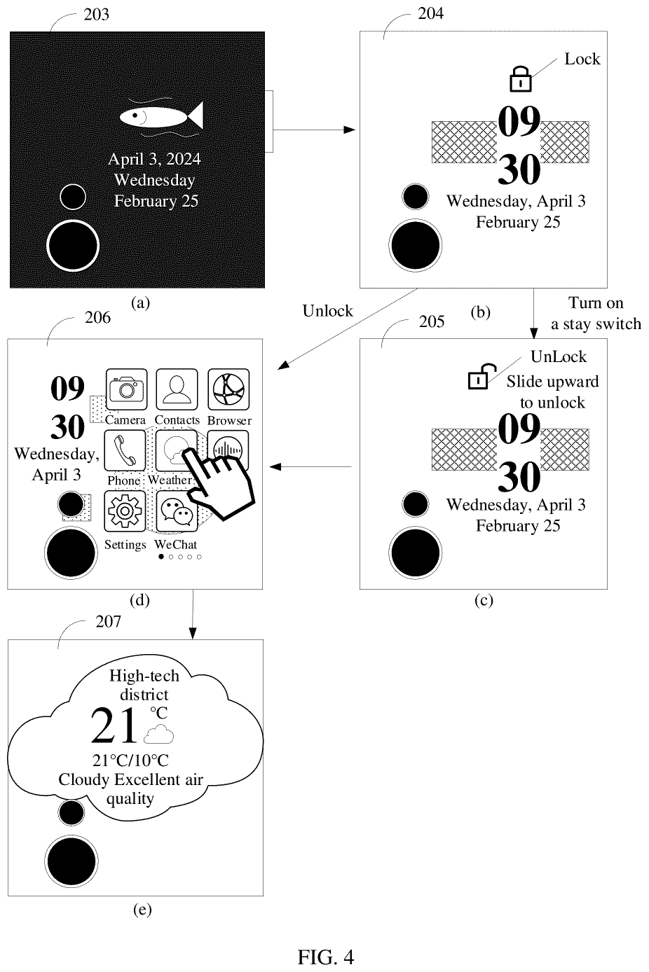

The small foldable mobile phone described in FIG. 2 is used as an example. FIG. 3 is a diagram of a display region of an outer screen of a small foldable mobile phone. FIG. 4 shows a displayed interface related to an outer screen of a small foldable mobile phone.

As shown in (a) in FIG. 3, a full-screen region of an outer screen may indicate a region A. As shown in (b) in FIG. 3, a left half region of the outer screen may indicate a region C, and a right half region may indicate a region B.

When the electronic device displays an always on display (always on display, AOD) interface, information such as a dynamic wallpaper and date may be displayed in the full-screen region or a local region of the outer screen. As shown in (a) in FIG. 4, a live swimming fish and static date may be displayed in a middle position of an always-on display interface 203.

When the electronic device receives a press operation for the power button or a double-tap operation for the outer screen, a lock screen interface 204 shown in (b) in FIG. 4 may be displayed in the full-screen region of the outer screen. A lock screen identifier included in the lock screen interface is in a locked state (lock). When the user performs unlocking in a fingerprint unlocking manner, a password unlocking manner, or a face unlocking manner and succeeds in the unlocking, the outer screen may switch from the lock screen interface to a home screen 206 shown in (d) in FIG. 4. In this case, the home screen 206 may include a clock, a date widget, a plurality of application icons, and the like.

Optionally, the full-screen region (region A) of the outer screen may be used to display a home screen wallpaper. Home screen content is divided into two parts, to display the home screen content in regions. For example, a left half region (region C) may be used to display a widget, and a right half region (region B) may be used to display application icons of a plurality of applications. Certainly, the full-screen region (region A) of the outer screen may also be used to display home screen content. For example, a widget is centered and near an upper edge of the outer screen, and a plurality of application icons are located below the widget. This is not limited in this embodiment of this application.

The electronic device may detect a tap operation for any application icon on the home screen. In response to the tap operation, content displayed in the left half region of the outer screen may remain unchanged or may be changed, and the right half region may be used to display a related interface when an application runs. Alternatively, the full-screen region of the outer screen may be used to display a related interface when an application runs.

For example, for a system application, the electronic device may display a related interface in the full-screen region; and for a third-party application, the electronic device may be divided into regions and display a related interface in the right half region. Content displayed in the left half region may remain unchanged or may be changed. This is not limited in this embodiment of this application.

For example, for a weather application that belongs to the system application, the electronic device may detect a tap operation on an application icon that indicates the weather application on the home screen 206, as shown in (d) in FIG. 4. In response to the tap operation, the electronic device displays, in the full-screen region, an interface 207 after the weather application is started, as shown in (e) in FIG. 4.

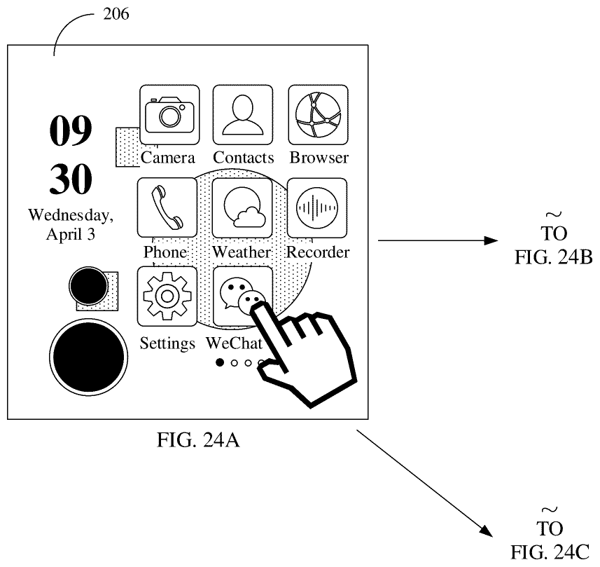

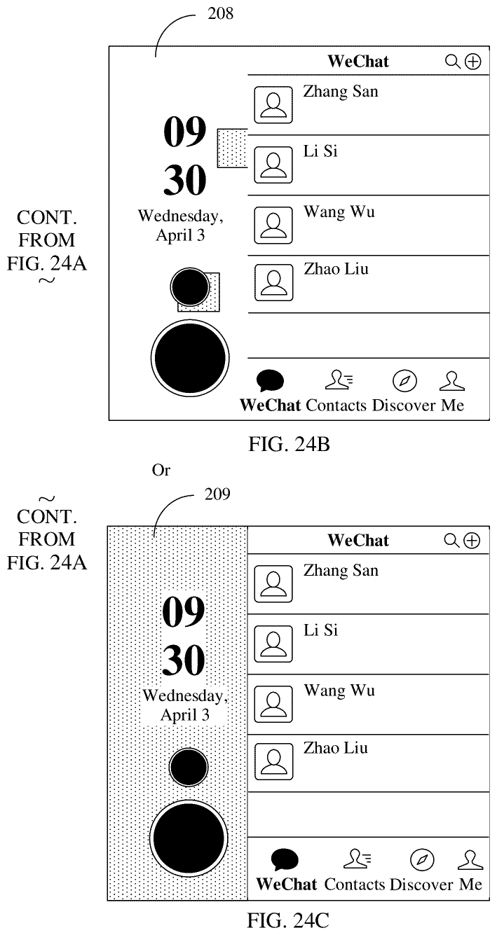

For example, for WeChat that belongs to the third-party application, the electronic device may detect a tap operation on an application icon that indicates WeChat on the home screen 206, as shown in FIG. 24A. In response to the tap operation, content displayed in the left half region of the outer screen may remain unchanged, and the right half region may be used to display a main interface of WeChat, such as an interface 208 shown in FIG. 24B. Alternatively, content displayed in the left half region of the outer screen may be changed. For example, a font size, a background color of the left half region, and a pattern are changed. In addition, the right half region is used to display a main interface of WeChat, for example, an interface 209 shown in FIG. 24C.

Based on the foregoing example in FIG. 4, with reference to (b) in FIG. 4, generally, a static wallpaper or a dynamic wallpaper may be displayed on the lock screen interface 204 displayed on the outer screen of the small foldable mobile phone. The static wallpaper is merely a static image, and is relatively boring. Although a common dynamic wallpaper can bring a sense of activity, the common dynamic wallpaper is limited by playing effect of a live video and lacks interaction with a user, which makes it less interesting for the user to use.

In view of this, an embodiment of this application provides a new method for displaying a dynamic wallpaper. The method may be applied to the outer screen of the foregoing small foldable mobile phone. When the outer screen displays the lock screen interface, one or more video sections corresponding to a theme package may be played in a preset order or a random order in response to the tap operation of the user, to enhance interest when the user uses the electronic device.

Optionally, when the outer screen displays the lock screen interface, in response to tap operations performed by the user for different hot zones, one or more different video sections may be displayed at corresponding hot zone positions based on different hot zones. In this case, a played video and a playing region on the lock screen interface change with a change of a tap position of the user.

Optionally, when the outer screen displays the lock screen interface, data of a sensor may be further obtained and identified. When it is determined that the electronic device is in a tilt state, one or more different video sections are played based on different tilt directions. In this case, a video on the lock screen interface changes with a tilt action of the user. Specifically, a subject object of a theme displayed on the lock screen interface may move with a tilt.

Optionally, when the outer screen displays the lock screen interface, data of a sensor may be further obtained and identified. When it is determined that the electronic device is in a shake state, one or more different video sections are played based on different shake directions. In this case, a video on the lock screen interface changes with a shake action of the user. Specifically, a subject object of a theme displayed on the lock screen interface may implement gravity sensing effect with a shake.

Optionally, when the outer screen displays the lock screen interface, data of a sensor may be further obtained and identified. When it is determined that the electronic device moves in a direction perpendicular to the screen, one or more different video sections may be played based on different relative movement distances. In this case, a video on the lock screen interface changes with a move action of the user. Specifically, a subject object of a theme displayed on the lock screen interface may move along a direction perpendicular to the screen with movement, to present visual effect of approaching or moving away.

It should be understood that the foregoing examples are merely several examples provided in this embodiment of this application, and these examples may be further combined and modified according to a requirement. This is not limited in this embodiment of this application. After the foregoing display manners are combined, change effect of the dynamic wallpaper is more abundant. Therefore, interactivity and interest of using the electronic device by the user can be increased.

In addition, the foregoing method for displaying a dynamic wallpaper in a status of tilting, shaking, and moving in a direction perpendicular to the screen may also be applied to an always-on display interface and a home screen on the outer screen.

Optionally, the method for displaying a dynamic wallpaper provided in this application may also be applied to a lock screen interface, an always-on display interface, or a home screen on an inner screen of the foldable screen. For a specific procedure, refer to embodiments provided below. Details are not described herein.

With reference to the accompanying drawings, the following describes in detail the lock screen interface and a software system of the electronic device related in this application.

Optionally, in an embodiment of this application, the lock screen interface may indicate the lock screen interface 204 shown in (b) in FIG. 4. In the lock screen interface 204 shown in (b) in FIG. 4, the lock screen identifier is in the locked state.

Optionally, in another embodiment of this application, for the lock screen interface 204 shown in (b) in FIG. 4, when a “Stay lock-screen after the outer screen is unlocked” switch on an application is set to on, and the user succeeds in unlocking but switching to the home screen is not implemented and switching to and staying at the interface shown in (c) in FIG. 4 are implemented, an interface that stays after the unlocking may also be referred to as a lock screen interface 205, that is, the lock screen interface may include the lock screen interface 204 and a lock screen interface 205. In the lock screen interface 205 shown in (c) in FIG. 4, the lock screen identifier is in an unlocked state (Unlock).

For the lock screen interface 204 shown in (b) in FIG. 4, unlocking may be performed in a manner such as face unlocking, fingerprint unlocking, or the like. After the unlocking, switching to the lock screen interface 205 shown in (c) in FIG. 4 may be implemented.

For the lock screen interface 205 shown in (c) in FIG. 4, still in response to an upward slide operation performed by the user, the lock screen interface 205 shown in (c) in FIG. 4 may be switched to the home screen 206 shown in (d) in FIG. 4. In addition, when the “Stay lock-screen after the outer screen is unlocked” switch on the application is set to off and the unlocking succeeds, the outer screen may be switched from the lock screen interface 204 shown in (b) in FIG. 4 to the home screen 206 shown in (d) in FIG. 4.

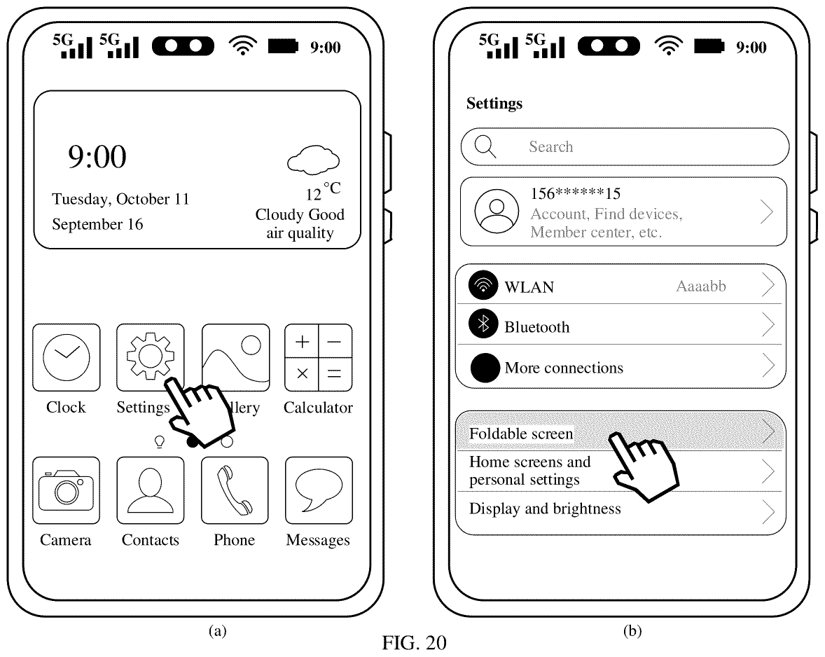

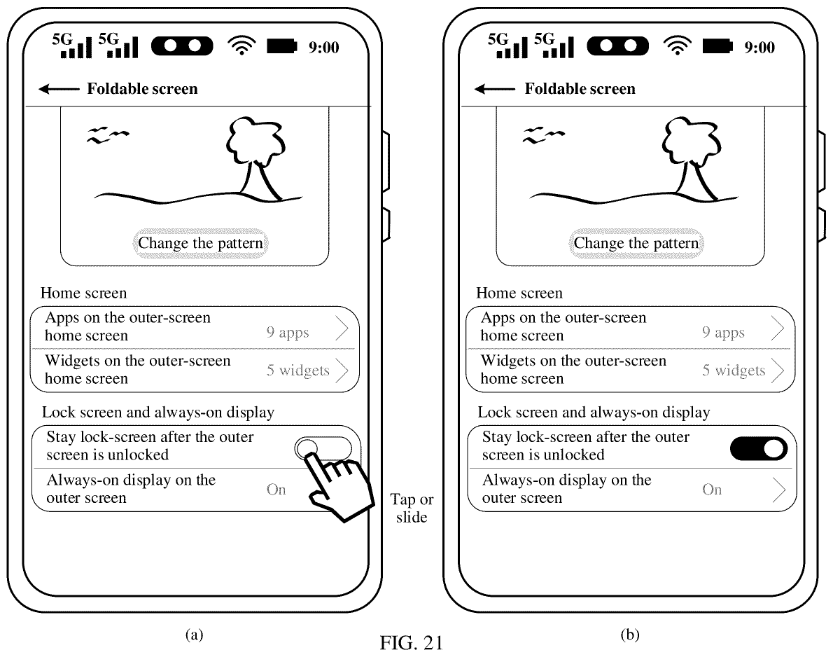

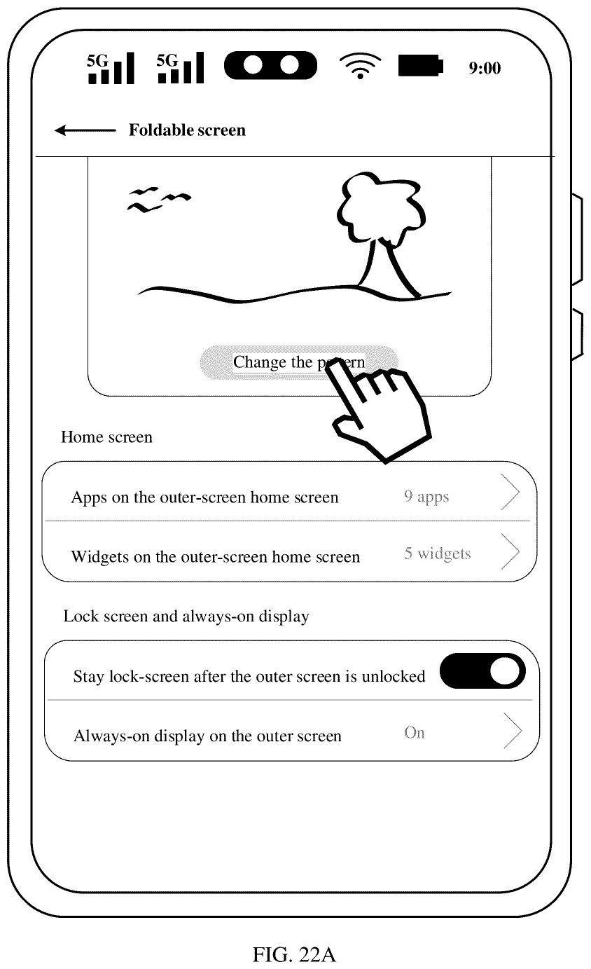

For a process of turning on or turning off the “Stay lock-screen after the outer screen is unlocked” switch, refer to the following descriptions of FIG. 20 and FIG. 21. Details are not described herein.

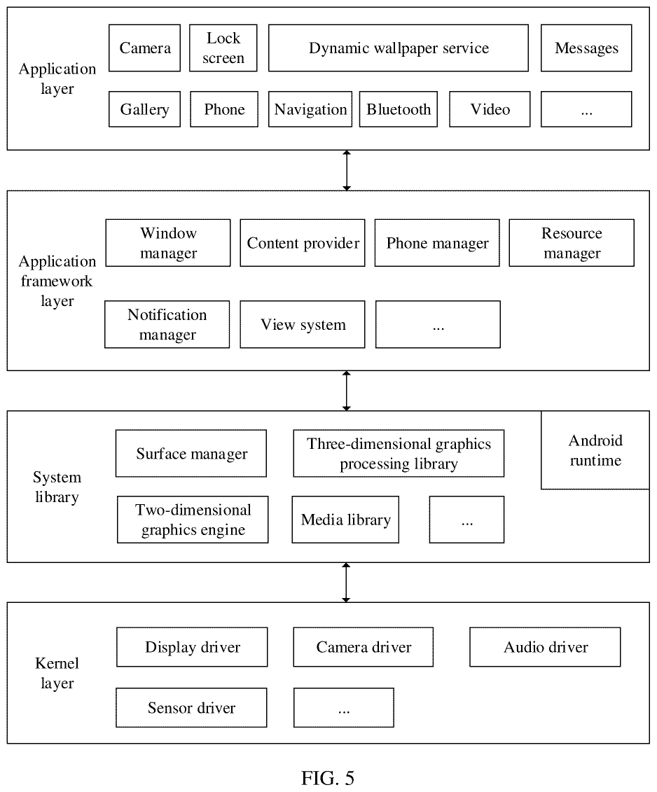

FIG. 5 is a diagram of a software system of an electronic device according to an embodiment of this application.

In a layered architecture of the electronic device 100, software is divided into several layers, and each of the layers has a clear role and task. The layers communicate with each other through software interfaces. In some embodiments, the Android system is divided into four layers: an application layer, an application framework layer, Android runtime (Android runtime) and a system library, and a kernel layer from top to bottom.

The application layer may include a series of application packages.

As shown in FIG. 5, the application packages may include a lock screen, and may further includes applications such as Camera, Gallery, Phone, Navigation, Bluetooth, Video, and Messages.

In this embodiment of this application, the application layer may further include a dynamic wallpaper service. The dynamic wallpaper service may receive an external input event sent by the lock screen (a first operation event, a second operation event, a third operation event, and the like related below), and/or obtain sensor data, and play different videos according to different operation control logic, to implement an interactive dynamic wallpaper.

In addition, the user may further create and modify a dynamic wallpaper of the user by using the dynamic wallpaper service, and perform display and interaction on the outer screen shown in FIG. 4. Specific creation and modification manners are not limited in this embodiment of this application.

The application framework layer provides an application programming interface (application programming interface, API) and a programming framework for applications at the application layer. The application framework layer includes some predefined functions.

As shown in FIG. 5, the application framework layer may include a window manager, a content provider, a view system, a phone manager, a resource manager, a notification manager, and the like.

The Android Runtime includes a core library and a virtual machine. The Android Runtime is responsible for scheduling and managing the android system.

The core library includes two parts: a function that needs to be called in a Java language and a core library of Android.

The application layer and the application framework layer run on the virtual machine. The virtual machine executes Java files of the application layer and the application framework layer as binary files. The virtual machine is configured to perform functions such as object lifecycle management, stack management, thread management, security and exception management, and garbage collection.

The system library may include a plurality of functional modules, for example, a surface manager (surface manager), a media library (Media Libraries), a three-dimensional graphics processing library (for example, OpenGL ES), and a 2D graphics engine (for example, an SGL).

The kernel layer is a layer between hardware and software. The kernel layer includes at least a display driver, a camera driver, an audio driver, a sensor driver, a Wi-Fi driver, and the like.

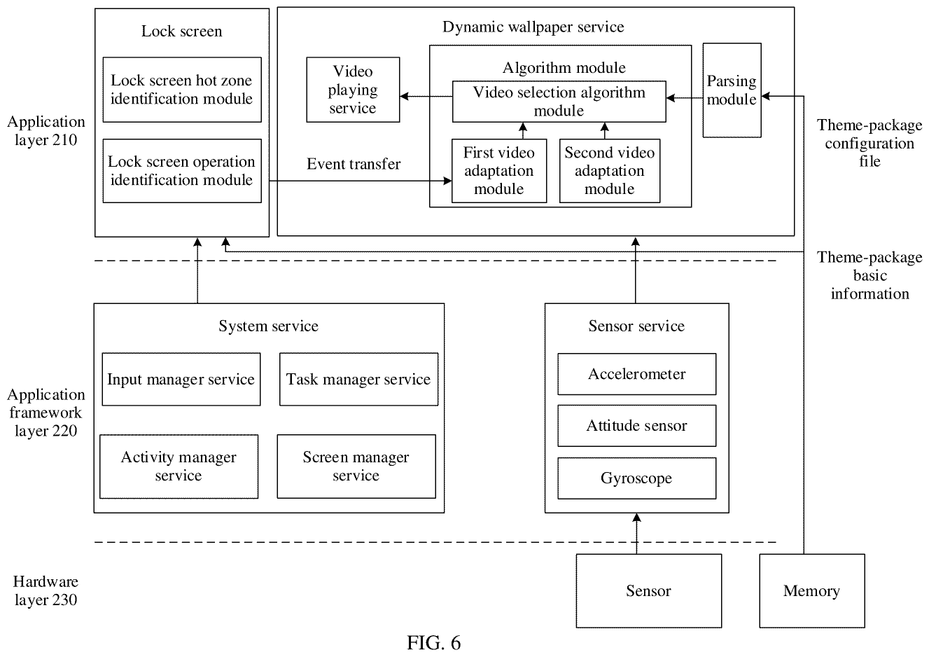

Based on FIG. 5, FIG. 6 is a diagram of a structure of another software system according to an embodiment of this application.

As shown in FIG. 6, at an application layer 210, a lock screen application may include a lock screen operation identification module and a lock screen hot zone identification module. A dynamic wallpaper service may include a parsing module, an algorithm module, a video playing service, and the like.

The lock screen operation identification module is configured to determine information such as an operation type, a triggered-button type, and triggered coordinates. The operation type indicates types to which different operations input by the user belong. For example, in response to a first operation event, when an electronic device displays a lock screen interface, the lock screen operation identification module may determine whether the user performs one of operations such as a tap operation, a double-tap operation, a touch-and-hold operation, or a slide operation. When the operation performed by the user is in an operation type of a tap operation, the lock screen operation identification module may be further configured to determine coordinate information corresponding to the tap operation. Certainly, the user operation may further include another operation. Correspondingly, the operation type may further include another operation type. This is not limited in this embodiment of this application.

The lock screen hot zone identification module is configured to: determine whether a hot zone is configured in a theme package (or referred to as a dynamic wallpaper); and when a hot zone is configured, determine a hot zone identifier of a corresponding hot zone based on coordinates triggered by the user, where different hot zones correspond to different hot zone identifiers.

In this embodiment of this application, a full-screen region of an outer screen may include one or more hot zones. When the full-screen region of the outer screen includes one hot zone, the hot zone includes only a local region in the full-screen region. When the full-screen region of the outer screen includes a plurality of hot zones, the plurality of hot zones may fill the full-screen region, or may occupy only a local region in the full-screen region. The hot zone may be in a regular shape or an irregular shape. Sizes of different hot zones may be the same or different.

Optionally, the algorithm module may include a first video adaptation module, a second video adaptation module, and a video selection algorithm module. The algorithm module is configured to determine adaptive video sections in different user interactions. The first video adaptation module is configured to determine an adaptive video section based on an external input operation event. The second video adaptation module is configured to determine an adaptive video section based on sensor data. The video selection algorithm module is configured to select, according to a preset selection policy from the video section determined by the first video adaptation module and a video section determined by a gravity sensing identification algorithm, a video section that is finally adaptive to be played.

The parsing module is configured to parse a configuration file, in an xml format, corresponding to the theme package.

The video playing service module is configured to play the selected adaptive video section based on a system resource.

The application framework layer 220 may include a system service and a sensor service. The system service is used to transfer, to the lock screen application, an external input event generated by a user operation received by the electronic device. The sensor service is used to transfer sensor data generated by a sensor; or is used to process sensor data, calculate an acceleration, an angle, or a pose, and then transfer a calculation result to the dynamic wallpaper service.

A hardware layer 230 includes a memory and a sensor.

The memory is configured to store first information, video resources, and configuration files that correspond to a plurality of theme packages. A one-to-one correspondence exists between the first information, the video resource, and the configuration file.

The sensor may include an accelerometer, a gyroscope sensor, an attitude sensor, and the like; and certainly, may further include another sensor. This is not limited in this embodiment of this application.

It should be noted that, any electronic device mentioned in embodiments of this application may include more or fewer modules in the electronic device.

The following describes in detail a method for displaying a dynamic wallpaper with reference to the modules in the software system shown in FIG. 6.

### 1. Example for Booting or Dynamic-Wallpaper Switching

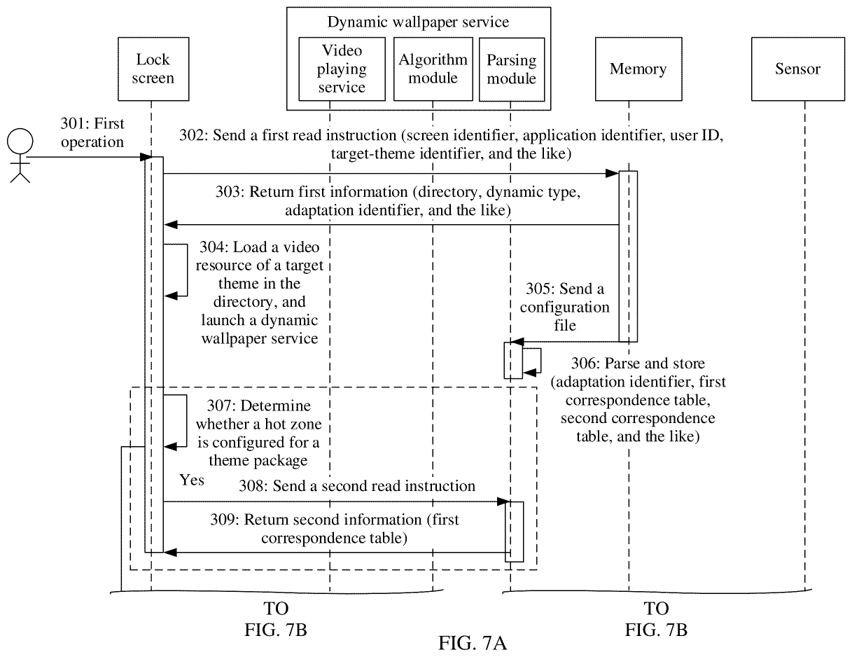

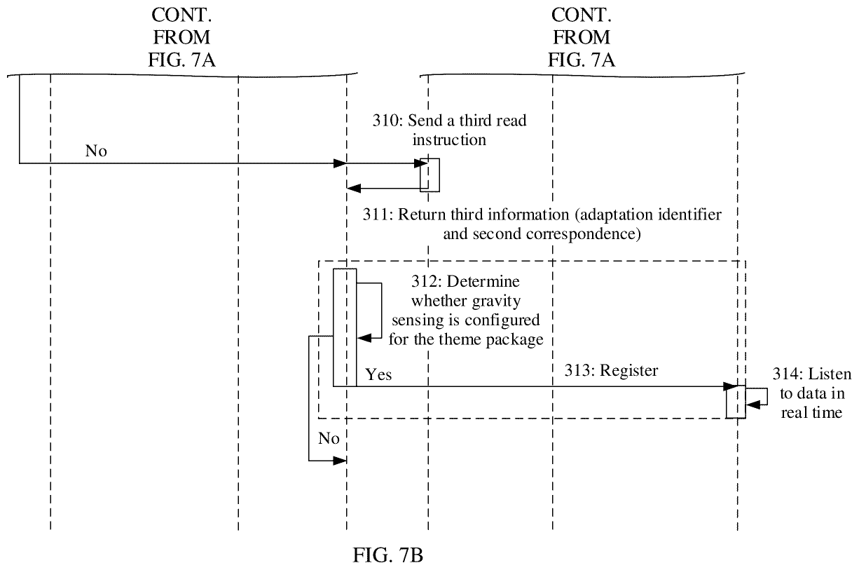

FIG. 7A and FIG. 7B are a schematic flowchart of a method for displaying a dynamic wallpaper according to an embodiment of this application. The method 300 includes step S301 to step S313. The following separately describes step S301 to step S313 in detail.

In this embodiment of this application, the method 300 may be performed by the electronic device shown in FIG. 2, and a lock screen interface relates to the lock screen interface 204 shown in (b) in FIG. 4 or the lock screen interface 205 shown in (c) in FIG. 4.

S301: A lock screen application receives a first operation of a user.

Optionally, the first operation may be a power-on operation or a theme switching operation. The power-on operation indicates a press-and-hold operation for a power button. In response to the power-on operation, the electronic device may switch from a power-off state to a power-on state. In this process, a preset theme or a theme displayed before power-off is loaded, and the loaded theme is a target theme. The theme switching operation is used to indicate a tap operation for an application control included in a preview interface of a new theme. In response to the tap operation, a theme of the electronic device may switch from an old theme to the new theme. The new theme is the target theme.

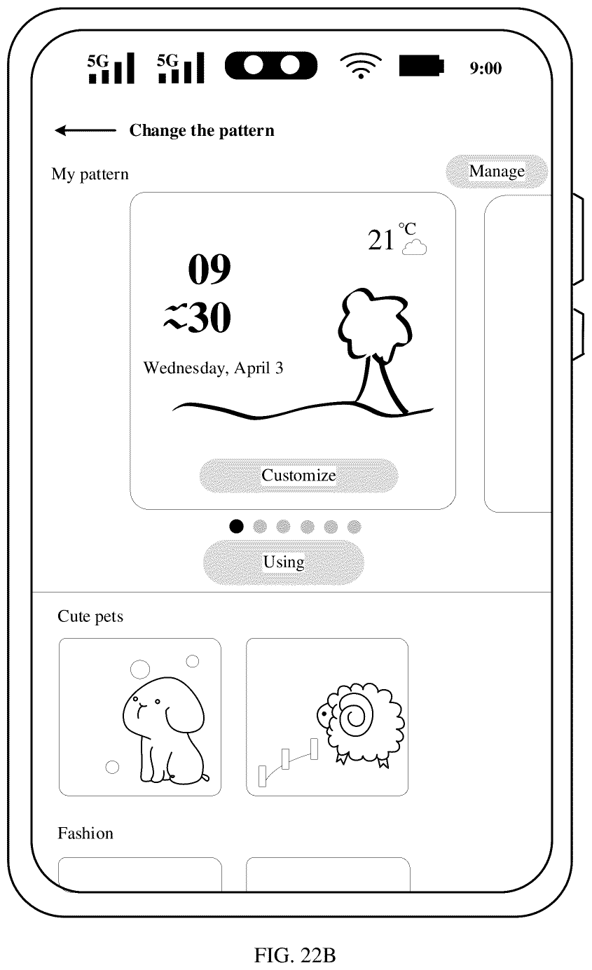

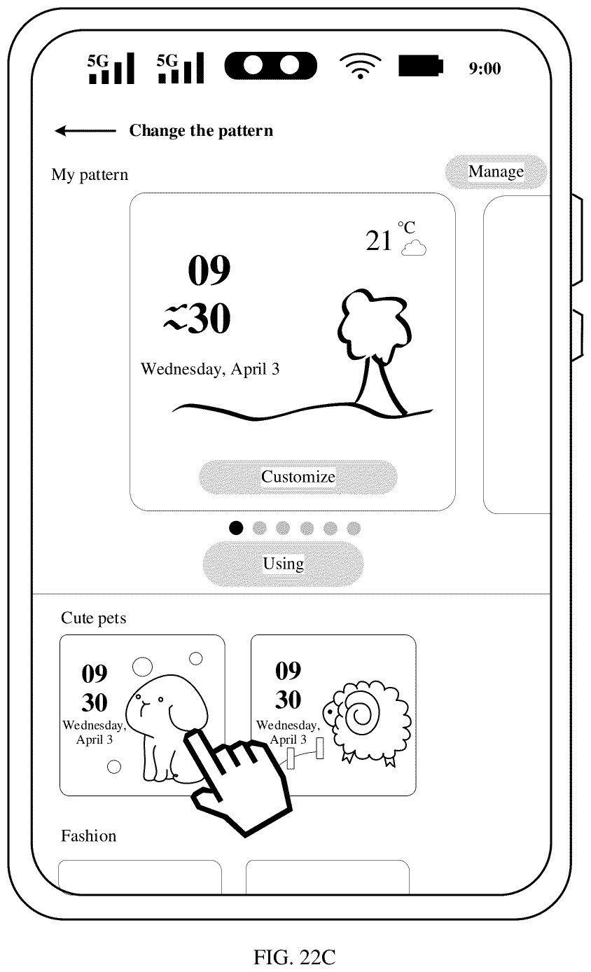

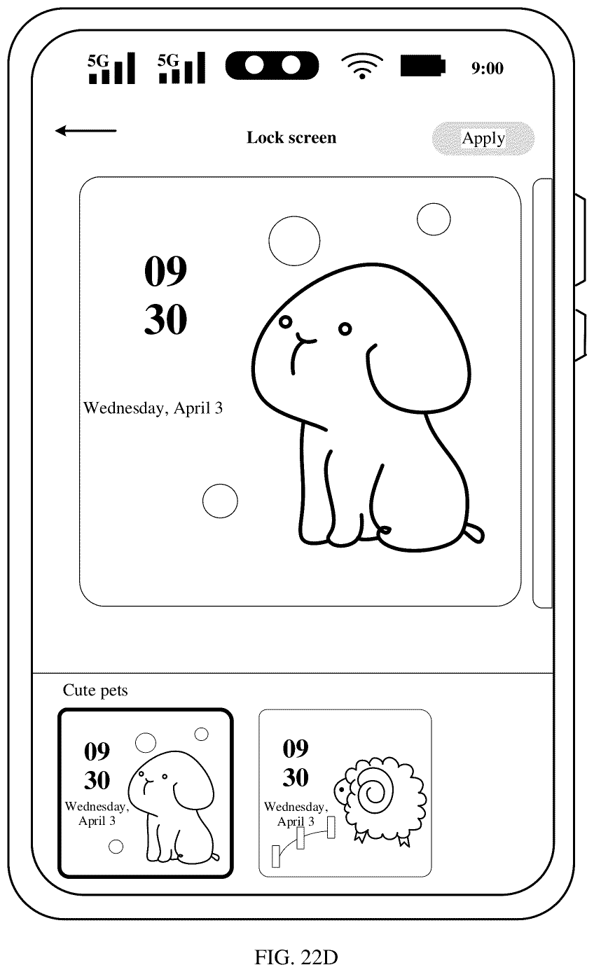

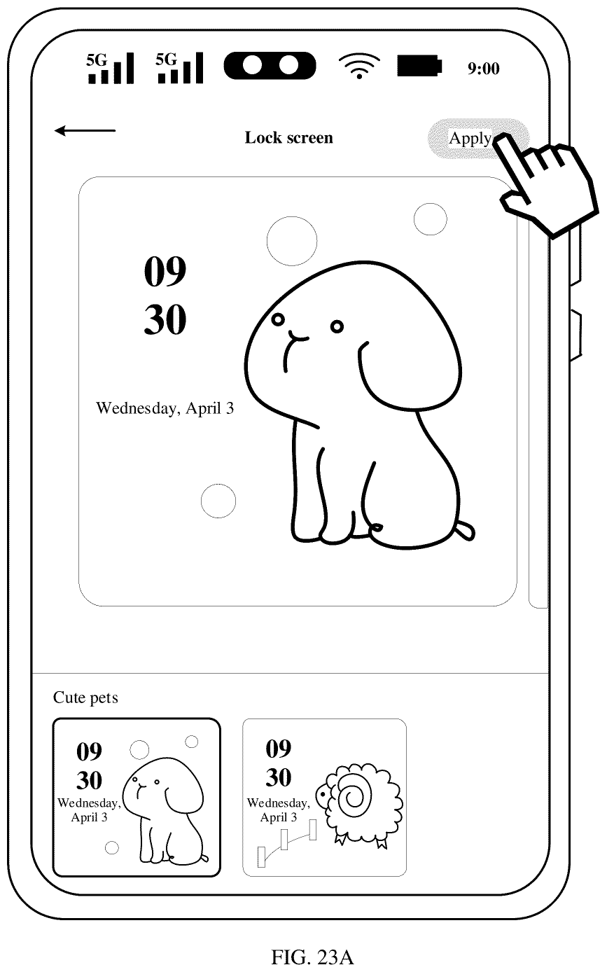

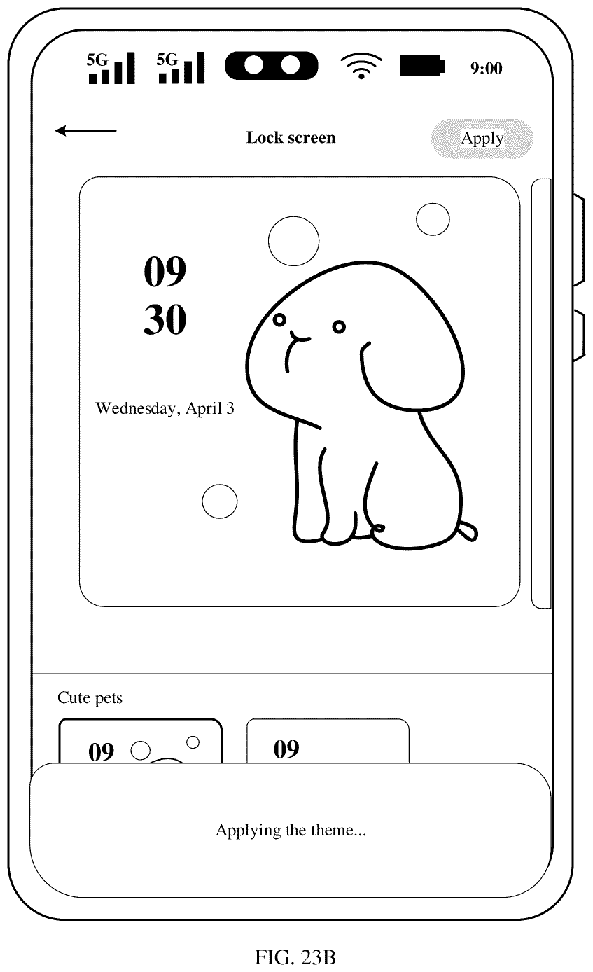

For example, for a theme switching process, refer to specific descriptions of FIG. 22A, FIG. 22B, FIG. 22C, FIG. 22D, FIG. 23A, and FIG. 23B below. The application control is an application control included in interfaces shown in FIG. 22D and FIG. 23A. Other content is not described herein.

S302: The lock screen application sends a first read instruction to a memory in response to the first operation.

Optionally, in response to the first operation, a system service generates and transfers a first operation event to the lock screen application; and the lock screen application sends the first read instruction to the memory based on the first operation event. It should be understood that the first operation event may indicate an event corresponding to the power-on operation or the theme switching operation.

Optionally, the first read instruction may carry source information, and the source information indicates a specific screen for which the first read instruction is used and a specific application from which the first read instruction comes. For example, the source information in the first read instruction may include an inner-screen identifier or an outer-screen identifier, and an application identifier of the lock screen application.

Optionally, the first read instruction may further carry a user ID.

Optionally, when the first operation event is the power-on operation, the first read instruction may carry a target-theme identifier, and the target-theme identifier indicates the theme displayed before power-off. When the first operation event is the theme switching operation, the first read instruction may further carry a target-theme identifier, and the target-theme identifier indicates a theme that needs to be displayed after switching.

In addition, in this embodiment of this application, the memory may be a read-only memory (Read-Only Memory, ROM).

S303: After receiving the first read instruction, the memory returns first information to the lock screen application.

The first read instruction instructs to read the first information. The first information includes a directory corresponding to a screen identifier and an application identifier that are included in the first read instruction. In this embodiment of this application, the directory may also be referred to as an address.

When the first read instruction further carries the user ID, the first information returned by the memory to the lock screen application may include a directory corresponding to the screen identifier, the application identifier, and the user ID that are included in the first read instruction. For example, the directory may be: inner screen data/theme/0; and outer screen data/theme/external/0; where 0 indicates the user ID, that is, identifies the user as a primary user.

In addition, the first information further includes some basic information. For example, the basic information may include: information such as whether a type of the target theme is static or dynamic, and an adaptation identifier that can be obtained from a configuration file.

It should be understood that the memory is configured to store theme packages respectively corresponding to a plurality of themes. The plurality of themes may include a plurality of preset themes and a theme that is customized and saved by the user. The theme package may include a video resource and a configuration file. The video resource of the theme may include a plurality of video sections in an order. The configuration file may be a file in an xml format.

When the first operation event is the power-on operation, the memory has copied and saved, in a fixed directory “data/theme/external/user ID”, a video resource and a configuration file of the theme displayed before power-off. In this case, in response to reception of the first read instruction, the memory may return, to the lock screen application, information such as the directory “data/theme/external/user ID”, the type of the target theme corresponding to the target theme in the directory, and some adaptation identifiers obtained from the configuration file.

When the first operation event is the theme switching operation, in response to the received first read instruction, the memory may search for the video resource and the configuration file of the target theme based on the carried target-theme identifier, and copy and save the video resource and the configuration file of the target theme to the directory “data/theme/external/user ID”. Then, the memory returns, to the lock screen application, the information such as the directory, the type of the target theme corresponding to the target theme in the directory, and some adaptation identifiers obtained from the configuration file.

It should be noted that, in this embodiment of this application, the memory copies and stores, in the fixed directory, the video resource and the configuration file that correspond to the target theme. Therefore, when the first information is returned, the target-theme identifier is no longer included. If the memory directly returns, in response to the received first read instruction, the directory corresponding to the target theme, the directory includes the target-theme identifier. For example, the directory, directly returned by the memory, of the target theme is “data/theme1/external/user ID”, and theme1 is the target-theme identifier.

S304: The lock screen application loads the video resource of the theme package based on the first information, and launches a dynamic wallpaper service.

In this embodiment of this application, a dynamic wallpaper needs to be displayed on the lock screen interface, and a type, included in the first information, of the target theme is a dynamic type. Therefore, based on the first information, the lock screen application may launch the dynamic wallpaper service. If the type, included in the first information, of the target theme is a static type, based on the first information, the lock screen application does not launch the dynamic wallpaper service, but invokes the static wallpaper of the theme package for display.

It should be understood that, based on the type that is of the target theme and that is included in the first information being the dynamic type, a process of loading the theme may include: loading the target theme from the fixed directory. The directory corresponding to loading the target theme may be: data/theme/external/0. 0 indicates the user ID. It is assumed that when the user ID is 100, the directory for loading the target theme applied to the outer screen may be: data/theme/external/100.

Optionally, the video resource of the theme may include a first group of video sections from an always-on display interface to the lock screen interface and a second group of video sections from the lock screen interface to a home screen, and the video resource of the theme is formed in an order in which the first group of video sections are followed by the second group of video sections. A last frame of the first group of video sections is adjacent to a first frame of the second group of video sections.

For example, the first group of video sections from the always-on display interface to the lock screen interface may be a video section played during switching from the interface shown in (a) in FIG. 4 to the interface shown in (b) in FIG. 4. The second group of video sections from the lock screen interface to the home screen may be a video section played between the interface shown in (b) in FIG. 4 and the interface shown in (d) in FIG. 4.

Optionally, the video resource of the theme may further include a third group of video sections adapted to a tap operation, and/or a fourth group of video sections adapted to gravity sensing, and/or a fifth group of video sections adapted to perpendicular screen movement. Certainly, the video resource of the theme may further include another video section. This is not limited in this embodiment of this application. Video sections adapted to different operation types such as tap and gravity sensing have adaptation identifiers corresponding to the video sections in the configuration file.

When the video resource of the theme includes the first group of video sections to the fifth group of video sections, the first group of video sections to the fifth group of video sections may be arranged in an order from the first group to the fifth group. In addition, each group of the first group of video sections to the fifth group of video groups may include one or more video sections.

Optionally, the spliced video resource may be in an MP4 format, or the spliced video resource may be in a format such as mov, avi, or mkv. Certainly, the spliced video resource may alternatively be in another video format. This is not limited in this embodiment of this application.

S305: After receiving the first read instruction, the memory may further send, to the dynamic wallpaper service, the configuration file corresponding to the target theme in the directory.

It should be understood that S304 and S305 may be performed sequentially, or may be performed simultaneously. This is not limited in this embodiment of this application.

The configuration file of the target theme may further include information such as a quantity of video sections, a quantity of hot zones, a coordinate range of each hot zone, a correspondence (or referred to as a second correspondence table) between each video section and gravity sensing, a correspondence (or referred to as a first correspondence table) between each video section and a hot zone, a type of a video playing order. The type of the video playing order may include a randomly playing type, a preset-order playing type, and the like.

For example, when the video resource of the theme includes the first group of video sections to the third group of video sections, the corresponding configuration file may include that a quantity of groups in the video resource is three and a total quantity of segments is five, and may further include a correspondence between video sections and different playing scenarios, and a correspondence between each video section and a hot zone. For example, the first group of video sections is a video section that needs to be played when the always-on display interface is switched to the lock screen interface, and includes only one video section; the second group of video sections is a video section that needs to be played when the lock screen interface is switched to the home screen, and includes only one video section; and the third group of video sections is a video section adapted to a hot zone, and includes three video sections. The foregoing is merely an example of the configuration file corresponding to the video resource.

The configuration file of the target theme may include some adaptation identifier information corresponding to the target theme, and the adaptation identifier information indicates that a video section belongs to a video group that is in the video resource and that is adapted to different playing scenarios.

For example, a first adaptation identifier <aod_lock_section> may indicate that one or more video sections are adapted from the always-on display interface to the lock screen interface; a second adaptation identifier <lock_launcher_section> may indicate that one or more video sections are adapted from the lock screen interface to the home screen; a third adaptation identifier <tap_video_section> may indicate that one or more video sections are adapted to a tap operation; a fourth adaptation identifier <hotzone_video_section> may indicate that one or more video sections are adapted to a hot zone; a fifth adaptation identifier <sensor_video_section> may indicate that one or more video sections are adapted to gravity sensing; and a sixth adaptation identifier <tap_video_section_tap> may indicate a type of a video playing order by assigning a value.

S306: The dynamic wallpaper service parses and stores the parsed configuration file.

The configuration file corresponding to the target theme may be referred to as a target configuration file.

It should be understood that the lock screen application launches the dynamic wallpaper service, and creates a parsing module, to parse, by using the parsing module, the target configuration file corresponding to the target theme.

S307: The lock screen application determines, based on the first information of the target theme, whether a hot zone is configured for the theme. If the hot zone is configured for the theme, step S308 is performed. If the hot zone is not configured for the theme, step S310 is performed. In addition, after S308 and S309 are performed, S310 is further performed.

Optionally, a lock screen hot zone identification module included in the lock screen application may determine, based on the first information that is of the target theme and that is returned from the memory, whether the hot spot is configured for the target theme.

For example, whether the hot zone is configured for the target theme may be determined based on whether the first information of the target theme includes an adaptation identifier hotzone_video_section. For example, when the first information includes hotzone_video_section, it indicates that the hot zone is configured for the target theme; and when the first information does not include hotzone_video_section, it indicates that no hot zone is configured for the target theme.

S308: The lock screen application determines that the hot zone is configured for the theme, and sends a second read instruction to the dynamic wallpaper service.

Optionally, because the parsing module parses and stores the configuration file of the target theme, in this case, the lock screen application may send the second read instruction to the parsing module in the dynamic wallpaper service. The second read instruction instructs to read the parsed second correspondence table.

S309: The dynamic wallpaper service returns second information to the lock screen application.

Optionally, the dynamic wallpaper service may return the parsed second information to the lock screen hot zone identification module in the lock screen application. The lock screen hot zone identification module may receive and store the returned second information.

The second information of the target theme may include the first correspondence table indicating the correspondence between each video section and a hot zone. For example, the first correspondence table may include: a quantity of hot zones, a hot zone identifier, a coordinate range of each hot zone, an identifier <hotzone_video_section> of a video section related to a hot zone, and a correspondence between a hot zone identifier indicating a hot zone and a first video section identifier indicating a video section.

For example, the second information of the target theme includes: a quantity of hot zones, hot zone identifiers of different hot zones, a coordinate range of each hot zone, and a correspondence between each video section identifier and a hot zone, as shown in Table 1.

TABLE 1

| Quantity | Identifiers | | |
|---|---|---|---|
| of hot | of hot | Coordinate | First video |
| zones | zones | range | section identifier |
| 1^{st} | R1 | (x1, y1), | <hotzone_video_section_R1> |
| | | (x2, y2) | |
| 2^{nd} | R2 | (x3, y3), | <hotzone_video_section_R2> |
| | | (x4, y4) | |

It should be understood that the foregoing is merely an example of the second information.

It should be noted that a first coordinate value in the coordinate range indicates coordinates of an upper-left corner endpoint of the hot zone, and a second coordinate value indicates coordinates of a lower-right corner endpoint of the hot zone. A rectangular region formed between the upper-left corner endpoint and the lower-right corner endpoint is a hot zone, and coordinates belonging to the coordinate range, namely, coordinates belonging to the rectangular region belong to the same hot zone.

In addition, because a correspondence also exists between the quantity of hot zones, the coordinate range, and the hot zone identifier, Table 1 is equivalent to storing a correspondence between the quantity of hot zones, the hot zone identifier, the coordinate range, and the first video section identifier. Subsequently, based on the first correspondence table, the other three pieces of information in a correspondence can be found based on any one piece of information.

S310: An algorithm module in the dynamic wallpaper service sends a third read instruction to the parsing module.

Optionally, because the parsing module parses and stores the configuration file of the target theme, in this case, a second video adaptation module included in an algorithm module may send the third read instruction to the parsing module. The third read instruction instructs to read the parsed third information of the target theme. The third information may also be referred to as gravity sensing information.

S311. The parsing module returns the third information to the dynamic wallpaper service.

Optionally, the parsing module returns the parsed third information to the second video adaptation module in the algorithm module. The second video adaptation module may receive and store the returned third information.

The third information of the target theme may include the second correspondence table indicating the correspondence between each video section and gravity sensing. For example, the second correspondence table may include: a gravity sensing type such as tilting, shaking, or perpendicular movement; and a correspondence between a sensor data range and an adaptation identifier <sensor_video_section> of a video section related to gravity sensing in different gravity sensing types.

Optionally, different corresponding sensors may be configured for different gravity sensing types. For example, when the gravity sensing type is tilting, only an attitude sensor and a gyroscope sensor corresponding to the gravity sensing type may be configured; when the gravity sensing type is shaking, an accelerometer, an attitude sensor, and a gyroscope sensor corresponding to the gravity sensing type may be configured; and when the gravity sensing type is perpendicular movement, an accelerometer and a gyroscope sensor corresponding to the gravity sensing type may be configured. This may be specifically set and modified according to a requirement. This is not limited in this embodiment of this application.

For example, in gravity sensing information of the target theme, data of three corresponding sensors: an accelerometer, an attitude sensor, and a gyroscope sensor is configured for different gravity sensing types.

A second correspondence between a gravity sensing type, a second video section identifier, and sensor data is included, as shown in Table 2.

TABLE 2

| Gravity | | |
|---|---|---|
| sensing type | Sensor data range | Second video section identifier |
| Tilt to the left | First acceleration range, | <sensor_video_section_E1>, |
| | first angle range, first | <sensor_video_section_E2> (A subject |
| | posture range | object is shifted to the left, Return) |
| Tilt to the right | Second acceleration range, | <sensor_video_section_E3>, |
| | second angle range, second | <sensor_video_section_E4> (A subject |
| | posture range | object is shifted to the right, Return) |
| Shake up to the | Third acceleration range, | <sensor_video_section_F1>, |
| left | third angle range, third | <sensor_video_section_F1> (A subject |
| | posture range | object is shifted up to the left, Return) |
| Shake up to the | Fourth acceleration range, | <sensor_video_section_F3>, |
| right | fourth angle range, fourth | <sensor_video_section_F4> (A subject |
| | posture range | object is shifted up to the right, Return) |
| Shake down to the | Fifth acceleration range, | <sensor_video_section_F5>, |
| left | fifth angle range, fifth | <sensor_video_section_F6> (A subject |
| | posture range | object is shifted down to the left, Return) |
| Shake down to the | Sixth acceleration range, | <sensor_video_section_F7>, |
| right | sixth angle range, sixth | <sensor_video_section_F8> (A subject |
| | posture range | object is shifted down to the right, Return) |
| Move forward | Seventh acceleration range, | <sensor_video_section_G1>, |
| perpendicularly | seventh angle range, seventh | <sensor_video_section_G2> (A subject |
| | posture range | object is scaled up, Return) |
| Move backward | Eighth acceleration range, | <sensor_video_section_G3>, |
| perpendicularly | eighth angle range, eighth | <sensor_video_section_G4> (A subject |
| | posture range | object is scaled down, Return) |

It should be understood that the foregoing is merely an example of the third information.

It should be noted that the sensor data range indicates that an acceleration, an angle, and a posture each are an interval range rather than a fixed value.

S312: The dynamic wallpaper service determines, based on the third information, whether gravity sensing is configured for the theme; and if gravity sensing is configured for the theme, performs subsequent S313; or if gravity sensing is not configured for the theme, waits to receive a subsequent instruction.

Optionally, the second video adaptation module included in the algorithm module may determine, based on the third information returned from the parsing module, whether gravity sensing is configured for the target theme.

For example, whether gravity sensing is configured for the target theme may be determined based on whether the third information of the target theme includes an adaptation identifier sensor_video_section. For example, when the second information includes <sensor_video_section>, it indicates that gravity sensing is configured for the target theme; and when the second information does not include <sensor_video_section>, it indicates that gravity sensing is not configured for the target theme.

S313: The dynamic wallpaper service registers with a sensor to listen to data.

Optionally, the second video adaptation module in the algorithm module included in the dynamic wallpaper service registers with the sensor to listen to the data. For example, one or more different types of sensors may be registered to listen to a timestamp of sensor data and a sensor data value. An accelerometer may be registered by registering type_accelerometer_sensor, a gyroscope sensor may be registered by registering type gyro_sensor, and an attitude sensor may be registered by registering type_attitude_sensor, and the like.

S314: The sensor listens to data in real time.

It should be noted that, in this embodiment of this application, when the outer screen of the electronic device is locked, the sensor may be registered; and when the outer screen of the electronic device is switched from the lock screen to the always-on display, or when the outer screen of the electronic device is switched from the lock screen to the home screen, the sensor may be automatically deregistered, and no longer monitor sensor data for display of a dynamic wallpaper on the lock screen to reduce power consumption.

The foregoing is a diagram of an interaction procedure of booting or dynamic-wallpaper switching.

It should be understood that an order of the steps included in FIG. 7A and FIG. 7B may be adjusted, added, or deleted according to a requirement. This is not shown in this embodiment of this application.

Optionally, in another example, in step S303, the first information returned by the memory to the lock screen may include information such as the type of the target theme being the dynamic type, but not include some adaptation identifiers obtained from the configuration file. Correspondingly, after step S306 and before step S310, the dynamic wallpaper service may be configured to perform S307 to S309.

Specifically, the algorithm module in the dynamic wallpaper service may be configured to perform S307 to S309.

For example, the algorithm module in the dynamic wallpaper service sends a fourth read instruction to the parsing module, where the fourth read instruction instructs to read fourth information. The fourth information may include an adaptation identifier hotzone_video_section.

Based on the returned fourth information, the algorithm module in the dynamic wallpaper service may determine that the hot zone is configured for the target theme. Then, the algorithm module sends a fifth read instruction to the parsing module. The fifth read instruction instructs to read the parsed fifth information. The fifth information may be the same as the second information described above. Details are not described herein again.

Optionally, in still another example, in step S303, the first information returned by the memory to the lock screen may include information such as the type of the target theme being the dynamic type, but not include some adaptation identifiers obtained from the configuration file. Correspondingly, after step S306 and before S310, the dynamic wallpaper service may be configured to perform the following steps.

For example, the algorithm module in the dynamic wallpaper service sends a sixth read instruction to the parsing module, where the sixth read instruction instructs to read sixth information. The sixth information may include an adaptation identifier hotzone_video_section and the foregoing second information.

Based on the returned sixth information, the algorithm module in the dynamic wallpaper service may determine that the hot zone is configured for the target theme.

Optionally, in still another example, in step S303, the first information returned by the memory to the lock screen may include information such as the type of the target theme being the dynamic type, but not include some adaptation identifiers obtained from the configuration file. Correspondingly, after step S306, the dynamic wallpaper service may be configured to perform the following steps.

For example, the algorithm module in the dynamic wallpaper service sends a seventh read instruction to the parsing module, where the seventh read instruction instructs to read seventh information. The seventh information may include all adaptation identifiers, the second information, and the third information.

Based on the returned seventh information, the algorithm module in the dynamic wallpaper service may determine that the hot zone and gravity sensing are both configured for the target theme. Then, the algorithm module in the dynamic wallpaper service may continue to perform S313 and S314.

2. Example of Displaying a Dynamic Wallpaper after a Lock Screen Interface is Tapped when a Hot Zone and Gravity Sensing are not Configured for a Target Theme

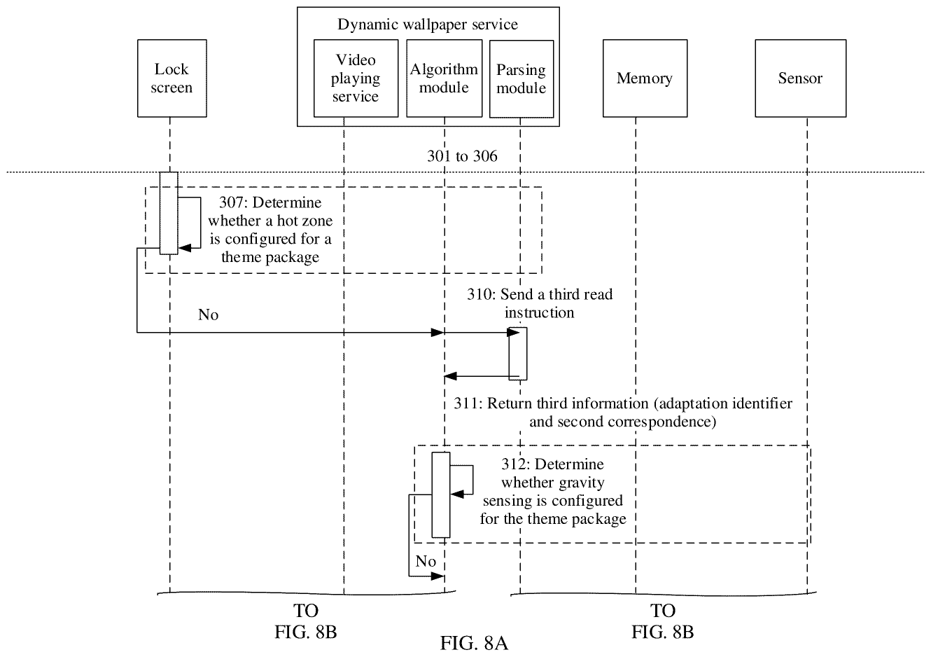

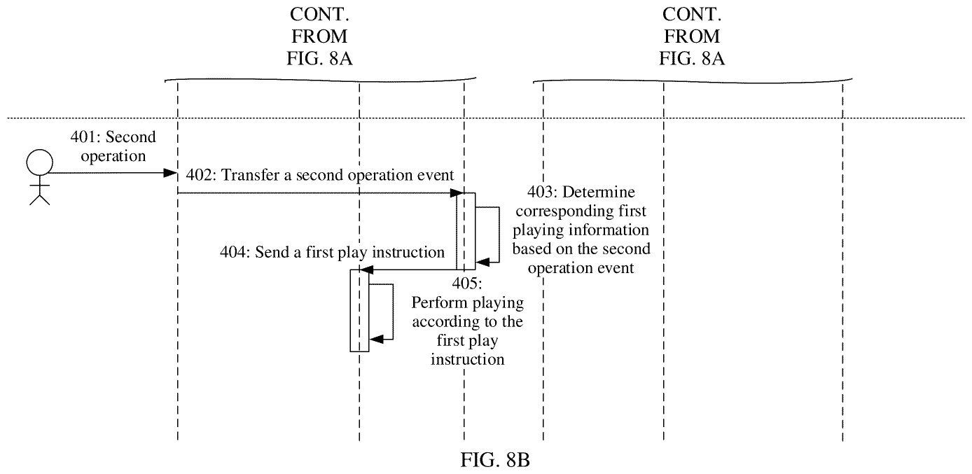

FIG. 8A and FIG. 8B are a schematic flowchart of another method for displaying a dynamic wallpaper according to an embodiment of this application.

When a hot zone and gravity sensing are not configured for a target theme, in addition to step S301 to step S307 and step S310 to step S312, the method 400 may further include step S401 to step S405. For step S301 to step S307 and step S310 to step S312, refer to the foregoing description of FIG. 7A and FIG. 7B. Details are not described herein again. The following separately describes step S401 to step S405 in detail.

In this embodiment of this application, the method 400 may be performed by the electronic device shown in FIG. 2, and a lock screen interface relates to the lock screen interface 204 shown in (b) in FIG. 4 or the lock screen interface 205 shown in (c) in FIG. 4.

S401: A lock screen application receives a second operation of a user.

Optionally, the second operation may be a user operation at any position on the lock screen interface. The user operation may include any one of operations such as a tap operation, a double-tap operation, a touch-and-hold operation, and a slide operation.

For example, the second operation may be a tap operation at any position on the lock screen interface 204 shown in (b) in FIG. 4 or the lock screen interface 205 shown in (c) in FIG. 4.

Optionally, a lock screen operation identification module included in the lock screen application is configured to determine information such as an operation type, a quantity of operations, a triggered-button type, and triggered coordinates. For details, refer to the description of the lock screen operation identification module in FIG. 6.

S402: The lock screen application transfers a second operation event to a dynamic wallpaper service.

Optionally, the lock screen operation identification module included in the lock screen application transfers the second operation event to an algorithm module in the dynamic wallpaper service. The second operation event may carry information such as an operation type determined by the lock screen operation identification module, a quantity of operations, and triggered coordinates, and may be specifically set according to a requirement. This is not limited in this embodiment of this application.

For example, when the second operation is a tap operation, the second operation event may be a tap event (tap event), and information that may be carried in the tap event includes: the operation type being a tap operation, coordinates of a tap position, and the like.

Optionally, in a process in which the user performs a tap operation, when it is detected that the user presses a finger (touchstart), the lock screen application may be triggered to transfer the second operation event to the dynamic wallpaper service; or when it is detected that the user lifts a finger (touchend), the lock screen application is triggered to transfer the second operation event to the dynamic wallpaper service. This is not limited in this embodiment of this application.

S403: The algorithm module in the dynamic wallpaper service determines corresponding first playing information based on the second operation event.

Optionally, the first playing information may include an adaptation identifier corresponding to the second operation event, a video section identifier corresponding to the adaptation identifier, a video frame interval range, a playing type, and the like.

For example, it is assumed that an input operation of the user is a tap operation, and the lock screen transfers the tap event to a first video adaptation module included in the algorithm module in the dynamic wallpaper service. The first video adaptation module may search for and determine adaptation identifiers <tap_video_section> and <tap_video_section_type> corresponding to the tap event from a parsed configuration file with reference to the operation type (click or referred to as tap) in the information carried in the tap event; and may further determine a corresponding video section identifier and a playing type of a video section from the parsed configuration file based on the two adaptation identifiers.

For example, video section identifiers corresponding to the tap operation are <tap_video_section_A1>, <tap_video_section_A2>, and <tap_video_section_A3>, and each video section identifier corresponds to a video section frame interval; and a value of <tap_video_section_type> is assigned as 1, to indicate that playing types of videos of the three video identifiers are sequentially playing.

S404: The algorithm module in the dynamic wallpaper service sends a first play instruction to a video playing service module.

The first play instruction instructs to play a corresponding video frame interval based on a determined video section identifier and an assigned value of a playing type. The first play instruction may carry the first playing information determined based on the second operation event.

Optionally, in response to one tap operation, one or more video sections are played sequentially or randomly based on the assigned value of the playing type.

S405: The video playing service module performs playing according to the first play instruction.

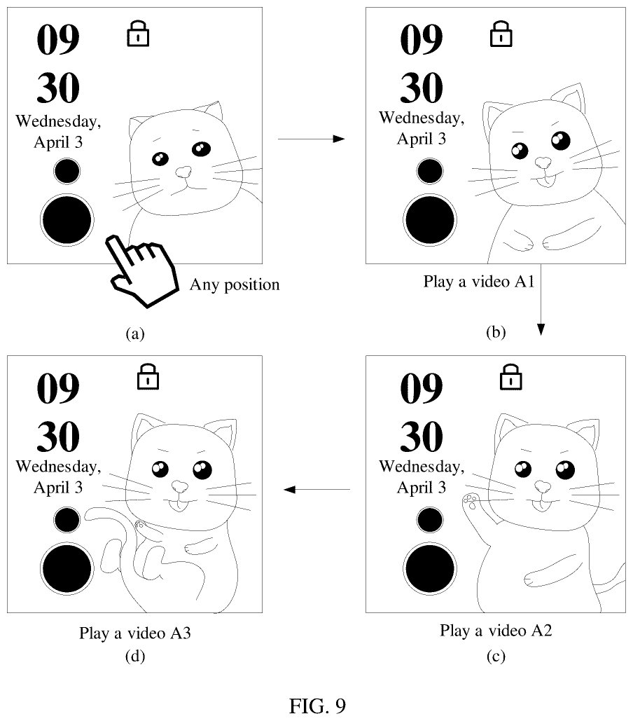

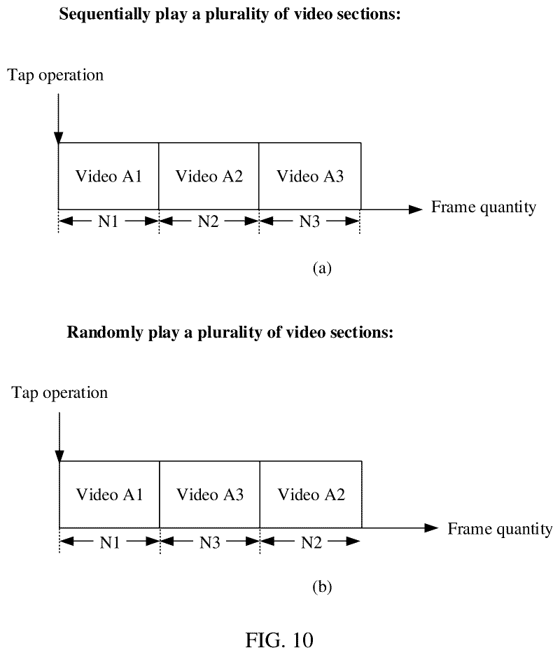

FIG. 9 is a diagram of related interfaces for playing a video section in response to a tap operation when a hot zone and gravity sensing are not configured. FIG. 10 is an example of played video sections.

For example, on a lock screen interface of an outer screen, as shown in (a) in FIG. 9, the electronic device may receive a tap operation at any position on the display. In response to the tap operation, the method shown in S401 to S405 may be performed to play a video section corresponding to the tap operation.

It is assumed that video section identifiers corresponding to a tap operation are <tap_video_section_A1>, <tap_video_section_A2>, and <tap_video_section_A3>. Each video section identifier corresponds to a video section frame interval. A value of <tap_video_section_tap> is 1, to indicate that playing types of the three video identifiers are sequentially playing. According to the first play instruction, a video frame interval corresponding to <tap_video_section_A1> may be sequentially played, for example, N1. A lock screen interface is shown in (b) in FIG. 9. Then, a second video frame interval corresponding to <tap_video_section_A2> is further played, for example, N2. A lock screen interface is shown in (c) in FIG. 9. Then, a third video frame interval corresponding to <tap_video_section_A3> is further played, for example, N3. A lock screen interface is shown in (d) in FIG. 9. A playing order is shown in (a) in FIG. 10.

Optionally, quantities of video frames included in the first video section frame interval, the second video section frame interval, and the third video frame interval may be the same or different. Correspondingly, playing durations may be the same or different.

Optionally, when a value of <tap_video_section_tap> is 0, a playing order of the first video section frame interval, the second video section frame interval, and the third video frame interval is randomly playing. For example, the playing order may be shown in (b) in FIG. 10.

The foregoing is the example of displaying a dynamic wallpaper after a lock screen interface is tapped when a hot zone and gravity sensing are not configured.

It should be noted that, when a dynamic wallpaper is displayed in response to a tap operation, as shown in the lock screen interface in FIG. 9, a displayed lock screen identifier may be in a locked state, or certainly may be in an unlocked state.

Optionally, in another example, after S405, in a period of playing a video section according to the first play instruction, if the electronic device receives a tap operation of the user again, the electronic device may stop playing. An index identifier may be created. A value is assigned to the index identifier, to record a number of a currently played video section and a number of a currently played frame. Afterward, if the electronic device receives a tap operation of the user for a third time, the electronic device may further play a quantity of subsequent video frames and the video section based on the number of the video section and the number of the frame that are recorded by the index identifier.

In this way, during execution of S405, in response to one or more tap operations of the user, a video played on the lock screen interface is paused or resumed until the plurality of video sections indicated by the first play instruction are played.

Optionally, in still another example, in response to a first tap operation, in S403, the first play instruction may instruct, based on a determined video section identifier and a playing type, to play a video corresponding to the first video section identifier. In addition, an index identifier may be created to record a quantity of currently played video sections. After the first video section is played, the electronic device may switch back to the original lock screen interface. Then, in response to a second tap operation, in S403, the first play instruction may instruct, based on a determined video section identifier, a playing type, and the index identifier, to play a video corresponding to the second video section identifier. In addition, an assigned value of the index identifier may be updated to record a quantity of video sections played in a second time. After the second video section is played, the electronic device may switch back to the original lock screen interface. Displaying processes corresponding to a plurality of subsequent tap operations are deduced by analogy. Details are not described herein again.

In this way, in response to each tap operation performed by the user, the lock screen interface plays only one video section adapted to the tap operation, and switches back to the original lock screen interface after the playing is completed; and in response to a next tap operation, plays another video section adapted to the tap operation. In other words, only one video section is played at each tap. A plurality of different video sections can be played only after a plurality of taps are manually performed, and the video sections are not automatically and continuously played.

Optionally, in step S405, the plurality of video sections indicated by the first play instruction may be cyclically played for a plurality of times until unlocking succeeds. The quantity of times of playing may be preset according to a requirement. This is not limited in this embodiment of this application.

For example, it is assumed that there are three video sections adapted to a tap operation, and a playing type is randomly playing. In response to a first tap operation, a video section A1 may be played, and a value of an index identifier is assigned as 1. In response to a second tap operation, a video section A3 may be played, and the value of the index identifier is assigned as 3. In response to a third tap operation, a video section A2 may be played, and the value of the index identifier is assigned as 2. Subsequently, in response to a fourth tap operation, randomly playing may continue. For example, the video section A3 is played, and the value of the index identifier is assigned as 3.

3. Example of Displaying a Dynamic Wallpaper after a Hot Zone is Tapped when a Hot Zone is Configured and Gravity Sensing is not Configured for a Target Theme

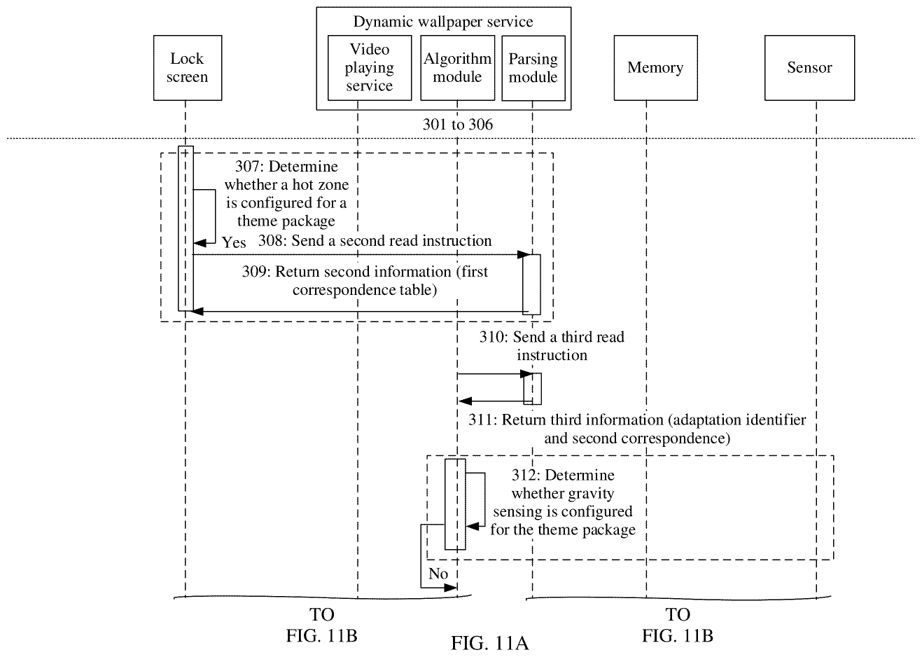

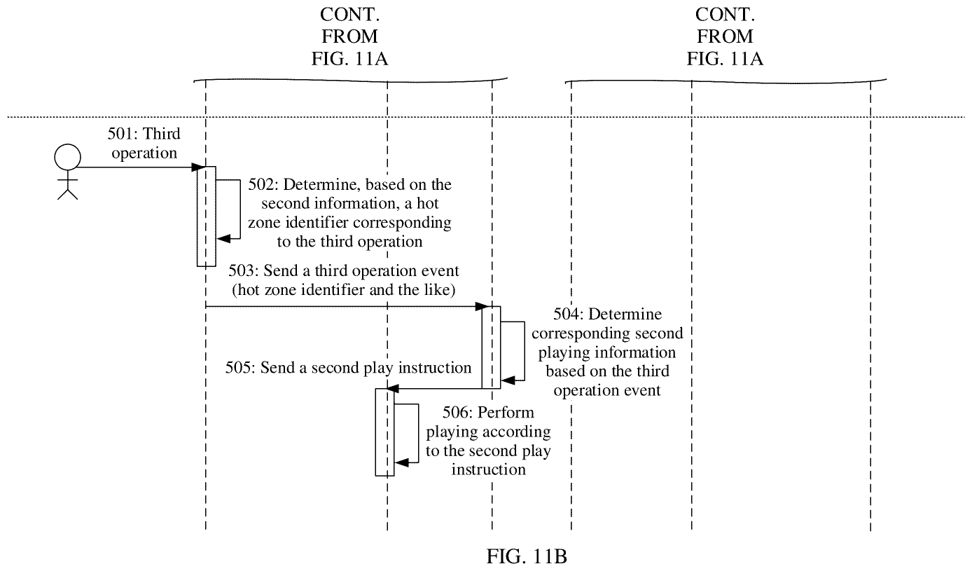

FIG. 11A and FIG. 11B are a schematic flowchart of still another method for displaying a dynamic wallpaper according to an embodiment of this application.

When a hot zone is configured and gravity sensing is not configured for a target theme, the method 500 may include step S301 to step S312 shown in FIG. 7A and FIG. 7B. On a basis, the method 500 may further include step S501 to step S506. For step S301 to step S312, refer to the foregoing description of FIG. 7A and FIG. 7B. Details are not described herein again. The following separately describes step S501 to step S506 in detail.

In this embodiment of this application, the method 500 may be performed by the electronic device shown in FIG. 2, and a lock screen interface relates to the lock screen interface 204 shown in (b) in FIG. 4 or the lock screen interface 205 shown in (c) in FIG. 4.

S501: A lock screen application receives a third operation of a user.

The third operation is similar to the second operation. For description of S501, refer to S401. Details are not described herein again.

For example, the third operation may be a tap operation at any position on the lock screen interface 204 shown in (b) in FIG. 4 or the lock screen interface 205 shown in (c) in FIG. 4.

S502: The lock screen application determines, based on the second information returned in S309, a hot zone corresponding to the third operation.

Optionally, a lock screen hot zone identification module included in the lock screen application is configured to determine, based on the received second information, the hot zone corresponding to the third operation. The hot zone triggered by the third operation may also be referred to as a current hot zone.

For example, the third operation is a tap operation. After receiving the tap operation performed by the user, a lock screen operation identification module sends coordinates corresponding to the third operation to the lock screen hot zone identification module. The lock screen hot zone identification module may perform one-to-one comparison between the coordinates and coordinate ranges (as shown in Table 1) that are of hot zones and that are included in the second information, to determine a specific coordinate range of a hot zone to which the coordinates belong. Then, a hot zone identifier corresponding to the coordinates may be determined based on the first correspondence between the coordinate range of the hot zone and the hot zone identifier shown in Table 1. A hot zone indicated by the hot zone identifier is the hot zone corresponding to the third operation.

For example, when the coordinates belong to a coordinate range of (x1, y1) and (x2, y2), it may be determined, based on the first correspondence, that the hot zone identifier corresponding to the coordinates is R1. In other words, the lock screen hot zone identification module may determine that the user taps a hot zone whose hot zone identifier is R1. Subsequently, a video section corresponding to the hot zone needs to be instructed to be played.

S503: The lock screen application transfers a third operation event to a dynamic wallpaper service.

Optionally, the lock screen hot zone identification module included in the lock screen application transfers the third operation event to a first video adaptation module in an algorithm module. The third operation event may carry the hot zone identifier determined by the lock screen hot zone identification module.

In addition, the third operation event may further carry information such as an operation type determined by the lock screen operation identification module and a quantity of operations, and may be specifically set according to a requirement. This is not limited in this embodiment of this application.

For example, when the third operation is a tap operation, information that may be carried in the third operation event includes: an operation type being a tap operation, and a hot zone identifier being R1.

S504: The algorithm module in the dynamic wallpaper service determines corresponding second playing information based on the third operation event.

Optionally, the second playing information may include a video section identifier corresponding to the hot zone identifier carried in the third operation event, a video frame interval corresponding to the video section identifier, and the like.

For example, it is assumed that an input operation of the user is a tap operation, and the lock screen transfers the tap event to the first video adaptation module included in the algorithm module in the dynamic wallpaper service. The first video adaptation module may determine, with reference to information carried in the tap event and a parsed configuration file, the first video section identifier corresponding to the hot zone identifier. The video frame interval indicated by the first video section identifier is a video corresponding to the hot zone.

For example, when it is determined that a hot zone identifier of a target hot zone is R1, it may be determined, by querying the configuration file, that the first video section identifier corresponding to the hot zone identifier R1 is <hotzone_video_section_R1>. In this case, a video that needs to be played is the video frame interval corresponding to the first video section identifier <hotzone_video_section_R1>.

Optionally, it is assumed that the first video section identifier corresponds to a plurality of video frame intervals. The plurality of video sections may be subsequently played in a configured order. In other words, for a hot zone, one or more video sections may be played in response to a tap operation of the user. Playing types of the plurality of video sections may be sequentially playing or randomly playing. This may be specifically set according to a requirement. This is not limited in this embodiment of this application.

Optionally, it is assumed that different first video section identifiers corresponding to different hot zone identifiers correspond to a same video frame interval or different video frame intervals. Subsequently, a same video section or different video sections may be played according to a configuration. In other words, for different hot zones, in response to a tap operation of the user, a same video section or different video sections may be played.

S505: The algorithm module in the dynamic wallpaper service sends a second play instruction to a video playing service module.

The second play instruction instructs to play a corresponding video frame interval based on a determined first video section identifier and an assigned value of a playing type. The first play instruction may carry the second playing information determined based on the third operation event.

S506: The video playing service module performs playing according to the second play instruction.

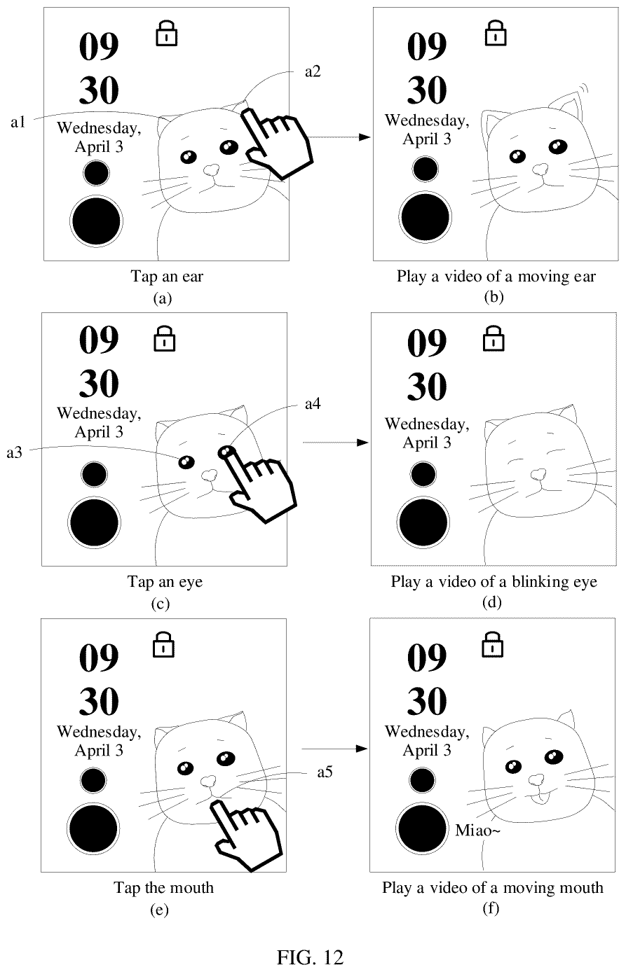

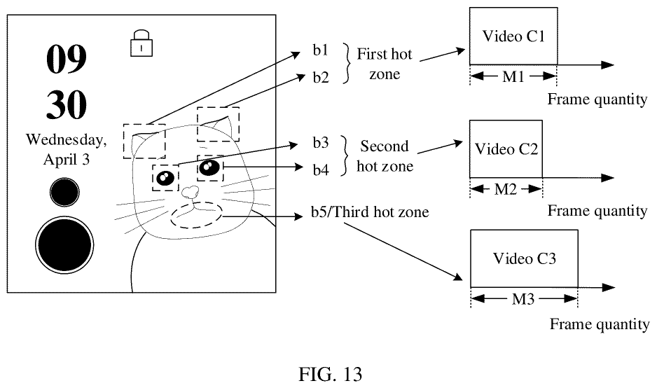

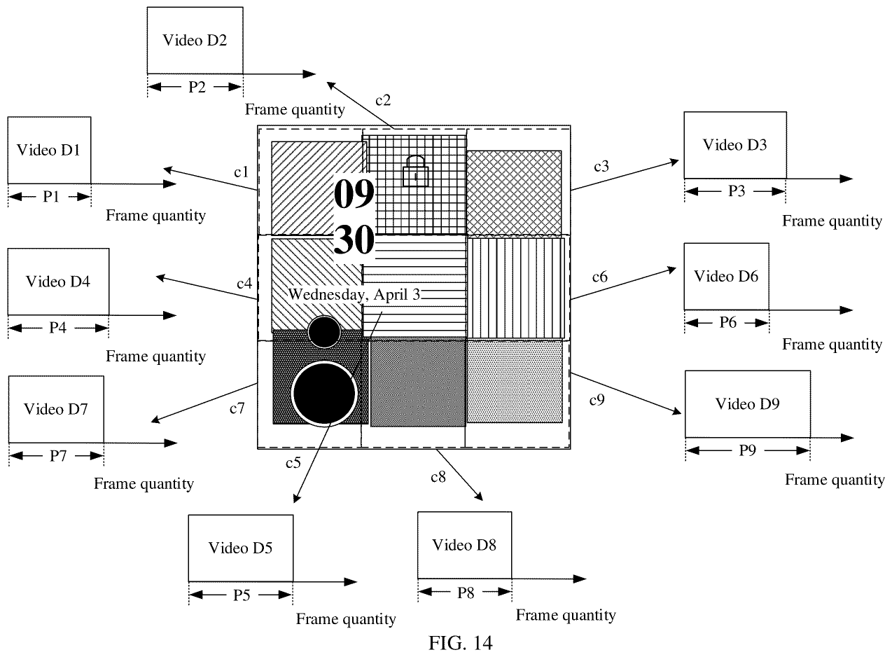

FIG. 12 is a diagram of related interfaces for playing a video section in response to a tap operation when a hot zone is configured and gravity sensing is not configured. FIG. 13 is a diagram of a correspondence between hot zones and video sections. FIG. 14 is another diagram of a correspondence between hot zones and video sections.

For example, for a theme displayed on a lock screen interface of an outer screen, as shown in (a) in FIG. 12, an electronic device may receive a tap operation for a displayed cat ear a1 or cat ear a2. In response to the tap operation, the method shown in S501 to S506 may be performed to play a video section corresponding to a hot zone triggered by the tap operation, as shown in (b) in FIG. 12. As shown in (c) in FIG. 12, the electronic device may receive a tap operation for a displayed cat eye a3 or cat eye a4. In response to the tap operation, the method shown in S501 to S506 is performed to play a video section corresponding to a hot zone triggered by the tap operation, as shown in (d) in FIG. 12. Likewise, as shown in (e) in FIG. 12, the electronic device may receive a tap operation for a displayed cat mouth a5. In response to the tap operation, the method shown in S501 to S506 is performed to play a video section corresponding to a hot zone triggered by the tap operation, as shown in (f) in FIG. 12.

As shown in FIG. 13, a first sub-hot zone b1 corresponding to the cat ear a1 and a second sub-hot zone b2 corresponding to the cat ear a2 both belong to a first hot zone. When a user taps any cat ear, a lock screen may determine that a triggered hot zone is the first hot zone. It is assumed that a hot zone identifier of the first hot zone is C1, and a corresponding first video section identifier is <topzone_video_section_C1>. In response to the tap operation, a video frame interval corresponding to the first video section identifier <topzone_video_section_C1> needs to be played, that is, a video C1.

In addition, a third sub-hot zone corresponding to the cat eye a3 and a fourth sub-hot zone b4 corresponding to the cat eye a4 both belong to a second hot zone. When the user taps any cat eye, the lock screen may determine that a triggered hot zone is the second hot zone. It is assumed that a hot zone identifier of the second hot zone is C2, and a corresponding first video section identifier is <topzone_video_section_C2>. In response to the tap operation, a video frame interval corresponding to the video section identifier <topzone_video_section_C2> needs to be played, that is, a video C2.

Similarly, a region b5 in which the cat mouth a5 is located belongs to a third hot zone. When the user taps the cat mouth, the lock screen may determine that a triggered hot zone is the third hot zone. It is assumed that an identifier of the third hot zone is C3, and a corresponding first video section identifier is <topzone_video_section_C3>. In response to the tap operation, a video frame interval corresponding to the first video section identifier <topzone_video_section_C3> needs to be played, that is, a video C3.

Optionally, as shown in FIG. 13, a quantity of frames of the video C1 is M1, a quantity of frames of the video C2 is M2, and a quantity of frames of the video C3 is M3. Quantities of video frames respectively included in different video sections may be the same or different. In other words, values of M1, M2, and M3 may be the same or different. Correspondingly, playing durations of different video sections may be the same or may be different.

The foregoing is the example of displaying a dynamic wallpaper after a tap when a hot zone is configured and gravity sensing is not configured.

It should be noted that, when a dynamic wallpaper is displayed in response to a tap operation, as shown in the lock screen interface in FIG. 12 or FIG. 13, a displayed lock screen identifier may be in a locked state, or certainly may be in an unlocked state.

Optionally, the hot zone may be a local region that does not fully fill an outer screen shown in FIG. 12 or FIG. 13, or may be a full-screen region that fully fills an outer screen shown in FIG. 14.

For example, as shown in FIG. 14, nine hot zones are configured for a theme currently displayed on the lock screen, the nine hot zones indicate nine local regions on the screen, the nine hot zones do not overlap each other, and the nine hot zones together may fill the full-screen region of the outer screen. When the user taps any hot zone, the lock screen may determine a hot zone identifier of the triggered hot zone and a first video section identifier corresponding to the hot zone identifier. It is assumed that, it is determined that a triggered hot zone is a first hot zone c1, a hot zone identifier of the first hot zone is D1, and a corresponding first video section identifier is <topzone_video_section_D1>. In response to the tap operation, a video frame interval corresponding to the first video section identifier <topzone_video_section_D1> needs to be played, that is, a video D1. It is assumed that, it is determined that a triggered hot zone is a ninth hot zone c9, a hot zone identifier of the ninth hot zone is D9, and a corresponding first video section identifier is <topzone_video_section_D9>. In response to the tap operation, a video frame interval corresponding to the first video section identifier <topzone_video_section_D9> needs to be played, that is, a video D9. Processes of triggering the second hot zone to the eighth hot zone are similar to the foregoing process. Reference may be made to the foregoing description. Details are not described herein again.

Optionally, as shown in FIG. 14, a quantity of frames of the video D1 is P1, a quantity of frames of the video D2 is P2, . . . , and a quantity of frames of the video D9 is P9. Quantities of video frames respectively included in different video sections may be the same or different. In other words, values of P1, P2, and P3 may be the same or different. Correspondingly, playing durations of different video sections may be the same or may be different.

Optionally, in FIG. 14, it is inconvenient for the user to perform a tap because a region of a non-under display camera is set on the outer screen. Therefore, hot zone configuration may not be performed. To be specific, a seventh hot zone may be omitted, and only eight hot zones are configured.

4. Example of Displaying a Dynamic Wallpaper During Tilting, Shaking, or Perpendicular Movement when a Hot Zone is not Configured and Only Gravity Sensing is Configured for a Target Theme

In an example, when a hot zone is not configured and gravity sensing is configured for a target theme, the method 600 may include step S301 to step S307 and step S310 to step S314 shown in FIG. 7A and FIG. 7B. On a basis, step S601 to step S607 may be further included.

In another example, when a hot zone is configured and gravity sensing is configured for a target theme, and no user operation for the hot zone is received, the method may include step S301 to step S314 shown in FIG. 7A and FIG. 7B. On this basis, step S601 to step S607 may be further included.

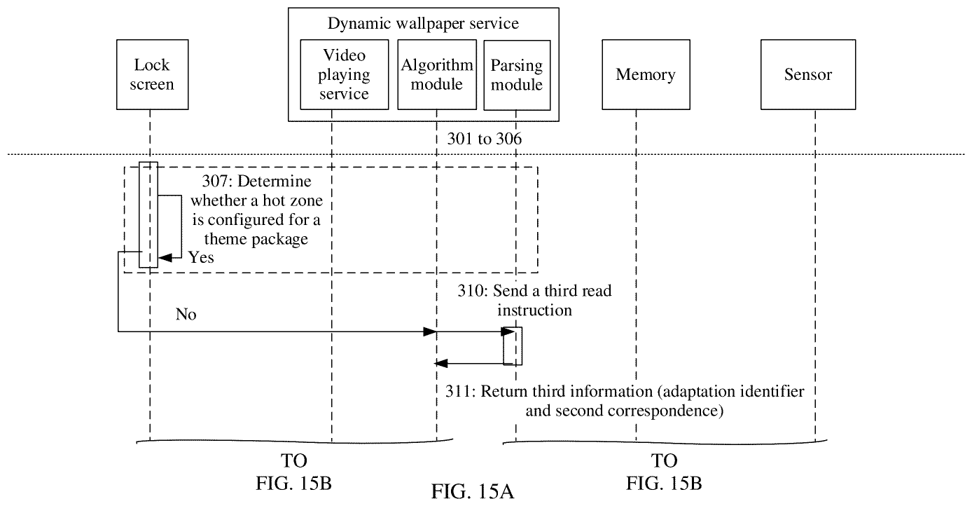

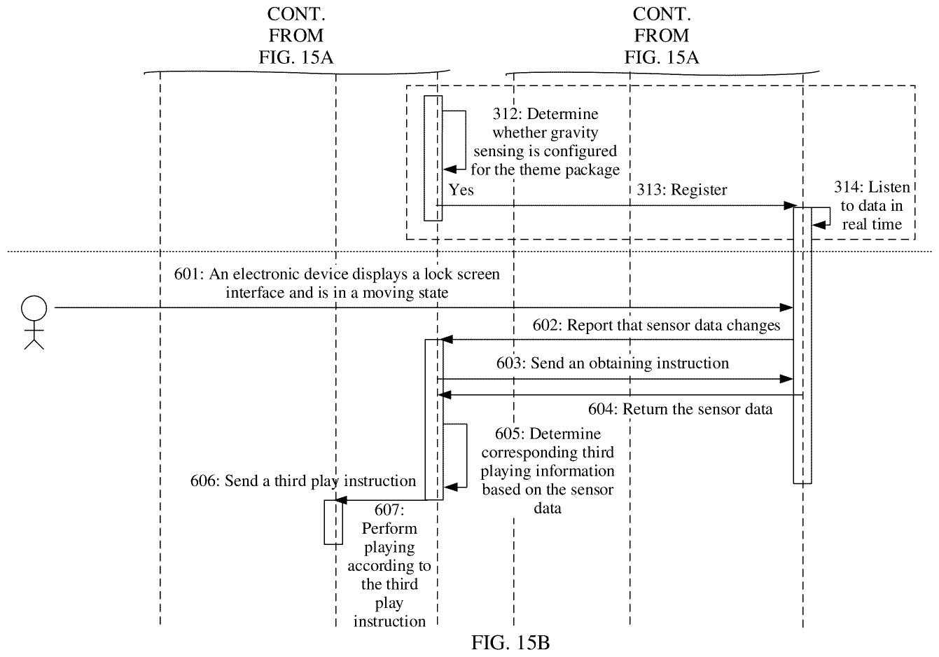

For the foregoing first example, FIG. 15A and FIG. 15B are a schematic flowchart of a method for displaying a dynamic wallpaper according to an embodiment of this application. For step S301 to step S307 and step S310 to step S314, refer to the foregoing description of FIG. 7A and FIG. 7B. Details are not described herein again. The following separately describes step S601 to step S607 in detail.

S601: An electronic device displays a lock screen interface and is in a moving state.

When the electronic device receives a press operation for a power button, the electronic device turns on a screen, and may display the lock screen interface 204 shown in (b) in FIG. 4 or the lock screen interface 205 shown in (c) in FIG. 4.

When a user changes a state of the electronic device in physical space, for example, the electronic device tilts, shakes, or moves in a direction perpendicular to the screen, the electronic device is in the moving state. Correspondingly, the moving state may include a tilt state, a shake state, or a state of moving in the direction perpendicular to the screen.

In this embodiment of this application, an order of triggered screen-on and motion of the electronic device is not limited.

S602: When detecting that sensor data changes, a sensor reports, to an algorithm module in a dynamic wallpaper service, that the sensor data changes.

Optionally, the sensor may report, to a second video adaptation module in the algorithm module by using a sensor service, that the sensor data changes.

It should be understood that when the sensor data changes, it indicates that a status of the electronic device in the physical space changes. In this case, a gravity sensing type may be further determined. Then, adapted video sections are adaptively played for different gravity sensing types, to implement gravity sensing effect of a subject object in the target theme.

Optionally, the gravity sensing type may include tilting to the left, tilting to the right, shaking up to the left, shaking up to the right, shaking down to the left, shaking down to the right, moving forward perpendicularly, or moving backward perpendicularly.

S603: The algorithm module in the dynamic wallpaper service sends an obtaining instruction to the sensor.

Optionally, after receiving reported information indicating that the sensor data changes, the second video adaptation module in the algorithm module may deliver the obtaining instruction. The obtaining instruction is used to obtain the sensor data.

S604: The sensor returns the sensor data to the dynamic wallpaper service.

Optionally, the sensor may return the sensor data to the second video adaptation module in real time by using a sensor service, or periodically return the sensor data collected within a preset duration.

Optionally, the sensor data may include information such as a sensor type, a timestamp of the sensor, and a value, and certainly, may alternatively be other information. This is not limited in this embodiment of this application.

S605: The dynamic wallpaper service determines corresponding third playing information based on the returned sensor data.

Optionally, after receiving the sensor data, the second video adaptation module in the algorithm module determines the third playing information based on the sensor data. The third playing information may include a gravity sensing type corresponding to the sensor data, a second video section identifier, a video frame interval corresponding to the second video section identifier, and the like.

For example, the second video adaptation module may first determine a corresponding acceleration, an angle, and a posture based on the sensor data returned by the sensor, such as the sensor type, the timestamp of the sensor, and the value; then, perform one-to-one comparison on the acceleration, the angle, the posture and a sensor data range (as shown in Table 2) included in gravity sensing information, to determine a specific sensor data range to which the sensor data belongs; and determine, based on the second correspondence between the sensor data range, the gravity sensing type, and the second video section identifier in Table 2, a gravity sensing type and a second video section identifier corresponding to the sensor data. The video frame interval indicated by the second video section identifier is a video corresponding to gravity sensing.

For example, when it is determined that the sensor data range belongs to a fourth acceleration range, a fourth angle range, and a fourth posture range, it may be determined that the corresponding gravity sensing type is shaking up to the right, that is, the electronic device is currently in a shake state. In addition, adapted second video section identifiers are <sensor_video_section_F3> and <sensor_video_section_F4>. In this case, a video that needs to be played is video frame intervals respectively corresponding to the second video section identifiers <sensor_video_section_F3> and <sensor_video_section_F4>.

S606: The algorithm module in the dynamic wallpaper service sends a third play instruction to a video playing service module.

The third play instruction instructs to play a corresponding video frame interval based on a determined second video section identifier. The third play instruction carries a video section identifier determined based on the sensor data.

S607: The video playing service module performs playing according to the third play instruction.

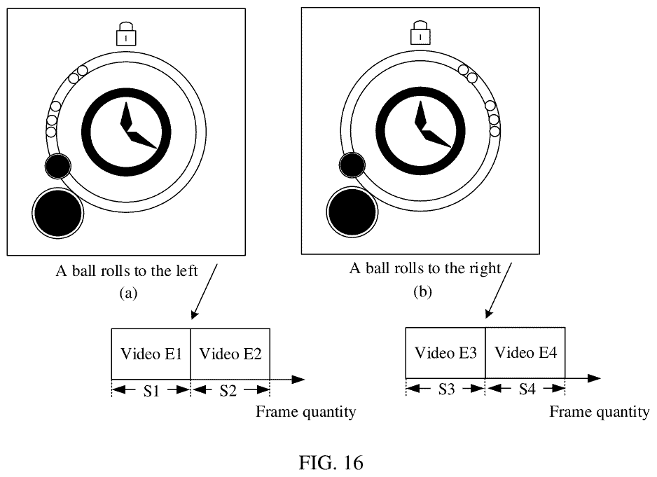

FIG. 16 is a diagram of related interfaces for playing a video section in response to a tilt operation when a hot zone is not configured and gravity sensing is configured.

For example, for a theme displayed on a lock screen interface of an outer screen, when an electronic device is in a tilt state, the method shown in S601 to S607 may be performed to play a video section corresponding to the tilt state.

As shown in (a) in FIG. 16, it is assumed that a user tilts the electronic device to the left, a gravity sensing type is tilting to the left, and second video section identifiers determined based on sensor data are <sensor_video_section_E1> and <sensor_video_section_E2>. The electronic device needs to play video frame intervals corresponding to the second video section identifiers <sensor_video_section_E1> and <sensor_video_section_E2>, that is, a video E1 and a video E2. After the playing, a ball on the lock screen interface may be in a status of returning from the right to the middle and rolling from the middle to the left.

As shown in (b) in FIG. 16, it is assumed that the user tilts the electronic device to the right, a gravity sensing type is tilting to the right, and second video section identifiers determined based on sensor data are <sensor_video_section_E3> and <sensor_video_section_E4>. The electronic device needs to play video frame intervals corresponding to the second video section identifiers <sensor_video_section_E3> and <sensor_video_section_E4>, that is, a video E3 and a video E4. After the playing, a ball on the lock screen interface may be in a status of returning from the left to the middle and rolling from the middle to the right.

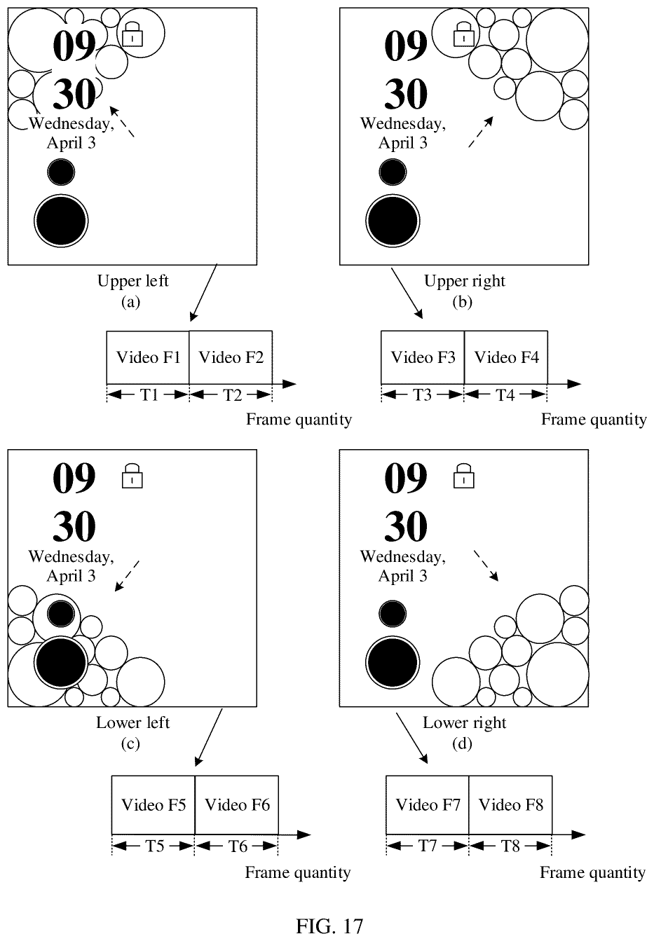

FIG. 17 is a diagram of related interfaces for playing a video section in response to a shake operation when a hot zone is not configured and gravity sensing is configured.

For example, for a theme displayed on a lock screen interface of an outer screen, when an electronic device is in a shake state, the method shown in S601 to S607 may be performed to play a video section corresponding to the shake state.

As shown in (a) in FIG. 17, it is assumed that a user shakes the electronic device up to the left, a gravity sensing type is shaking up to the left, and second video section identifiers determined based on sensor data are <sensor_video_section_F1> and <sensor_video_section_F2>. The electronic device needs to play video frame intervals corresponding to the second video section identifiers <sensor_video_section_F1> and <sensor_video_section_F2>, that is, a video F1 and a video F2. After the playing, a bubble on the lock screen interface may be in a status of returning from the lower right to the middle and rolling from the middle to the upper left.

Processes in (b) in FIG. 17, (c) in FIG. 17, and (d) in FIG. 17 are similar to the foregoing descriptions. Reference may be made to the foregoing descriptions. Details are not described herein again.

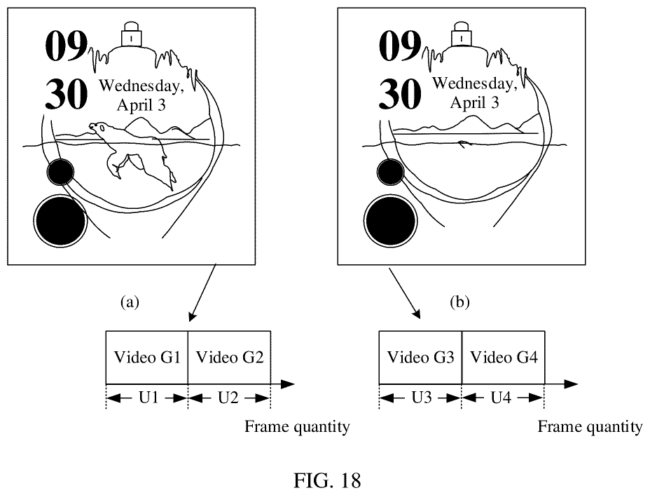

FIG. 18 is a diagram of related interfaces for playing a video section in response to a perpendicular move operation when a hot zone is not configured and gravity sensing is configured.

For example, for a theme displayed on a lock screen interface of an outer screen, when an electronic device is in a state of moving in a direction perpendicular to the screen, the method shown in S601 to S607 may be performed to play a video section corresponding to the state of moving in the direction perpendicular to the screen.

As shown in (a) in FIG. 18, it is assumed that a user moves the electronic device forward in the direction perpendicular to the screen, a gravity sensing type is moving forward perpendicularly, and second video section identifiers determined based on sensor data are <sensor_video_section_G1> and <sensor_video_section_G2>. The electronic device needs to play video frame intervals corresponding to the second video section identifiers <sensor_video_section_G1> and <sensor_video_section_G2>, that is, a video G1 and a video G2. After the playing, a polar bear on the lock screen interface may swim from the distant to the near and present visual effect of becoming larger.

As shown in (b) in FIG. 18, it is assumed that the user moves the electronic device backward in the direction perpendicular to the screen, a gravity sensing type is moving backward perpendicularly, and second video section identifiers determined based on sensor data are <sensor_video_section_G3> and <sensor_video_section_G4>. The electronic device needs to play video frame intervals corresponding to the second video section identifiers <sensor_video_section_G3> and <sensor_video_section_G4>, that is, a video G3 and a video G4. After the playing, a polar bear on the lock screen interface may swim from the near to the distant and present visual effect of becoming smaller.

Optionally, as shown in FIG. 16, FIG. 17, and FIG. 18, quantities of video frames included in different video frame intervals may be the same or different. Correspondingly, playing durations may be the same or different.

The foregoing is an example of displaying a dynamic wallpaper after tilting, shaking, or perpendicularly moving an electronic device when gravity sensing is configured.

It should be noted that, when the electronic device in a moving state displays a dynamic wallpaper, as shown in the lock screen interface in FIG. 16, FIG. 17, or FIG. 18, a displayed lock screen identifier may be in a locked state, or certainly may be in an unlocked state.

It should be understood that, when the user performs a tilt operation, a shake operation, or a perpendicular move operation for a plurality of times, a plurality of consecutive video frame intervals may be played based on different second video section identifiers determined based on sensor data. A process of playing different video frame intervals is similar to that in S601 to S607. Details are not described herein again.

5. Example of Displaying a Dynamic Wallpaper when a Hot Zone is Configured and Gravity Sensing is Configured for a Target Theme

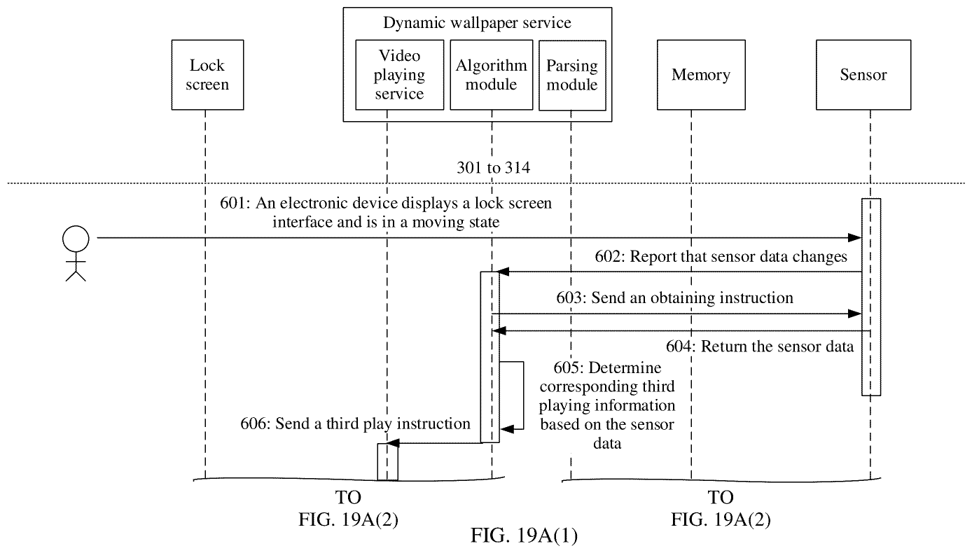

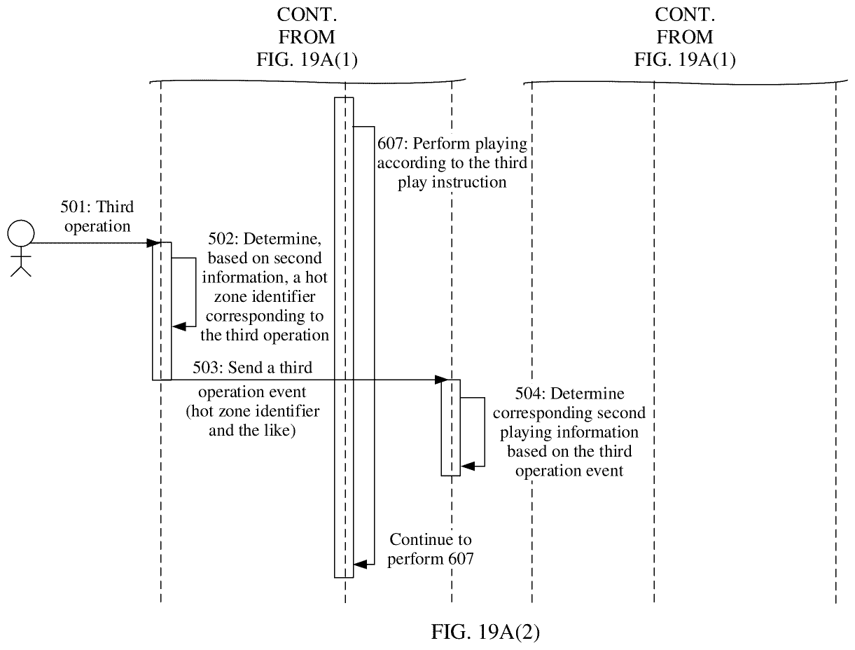

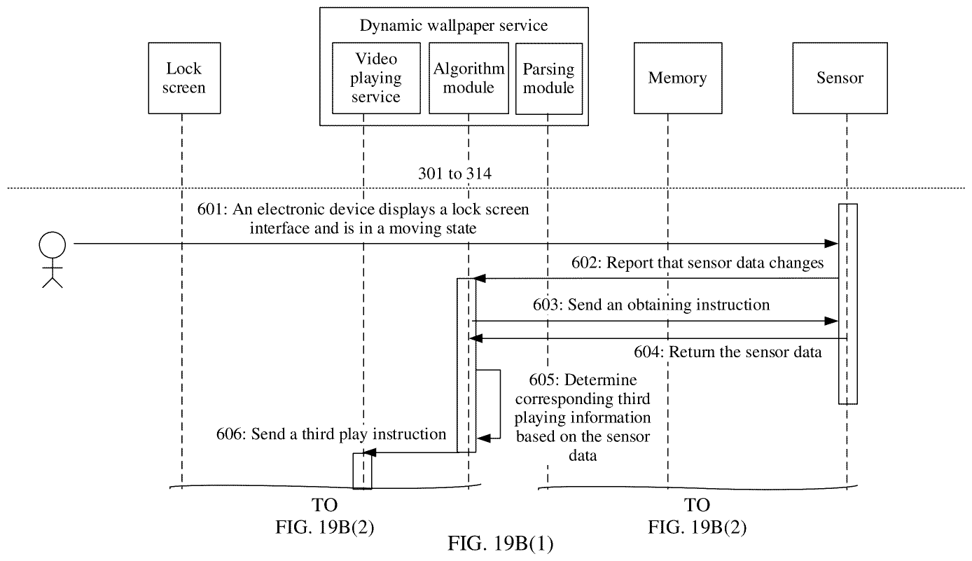

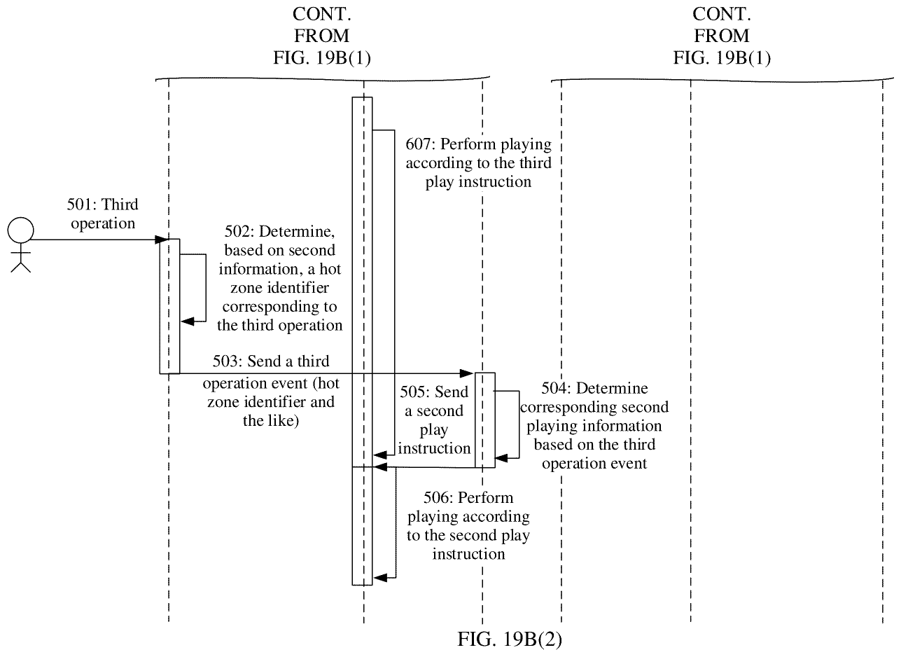

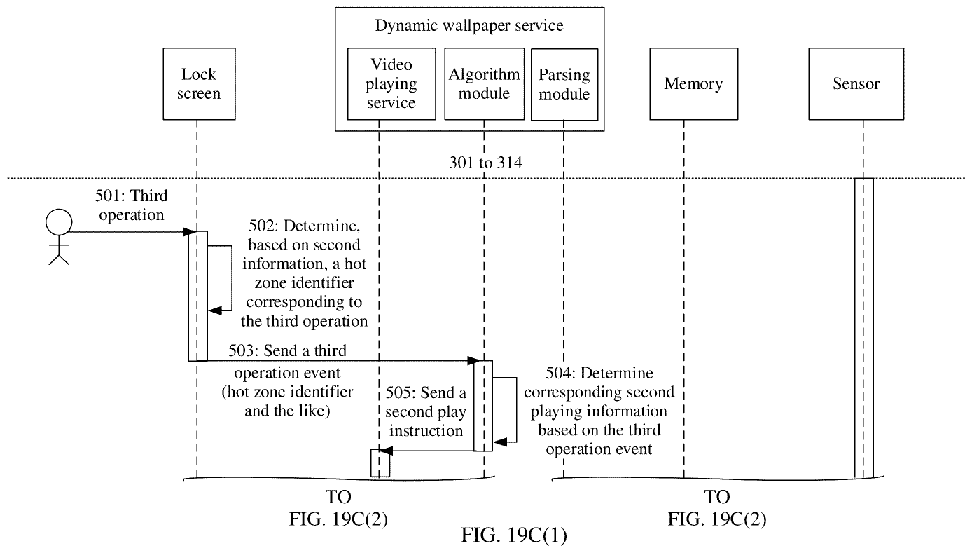

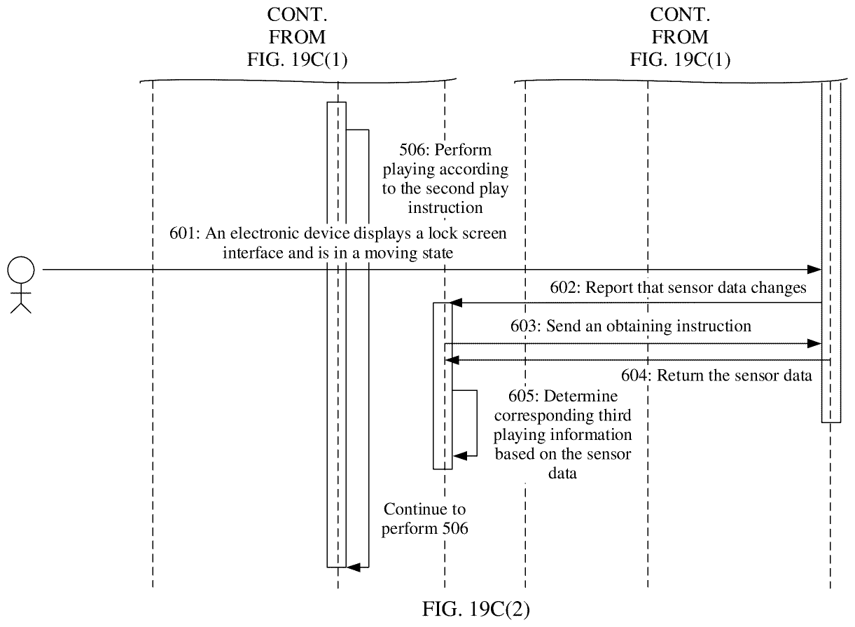

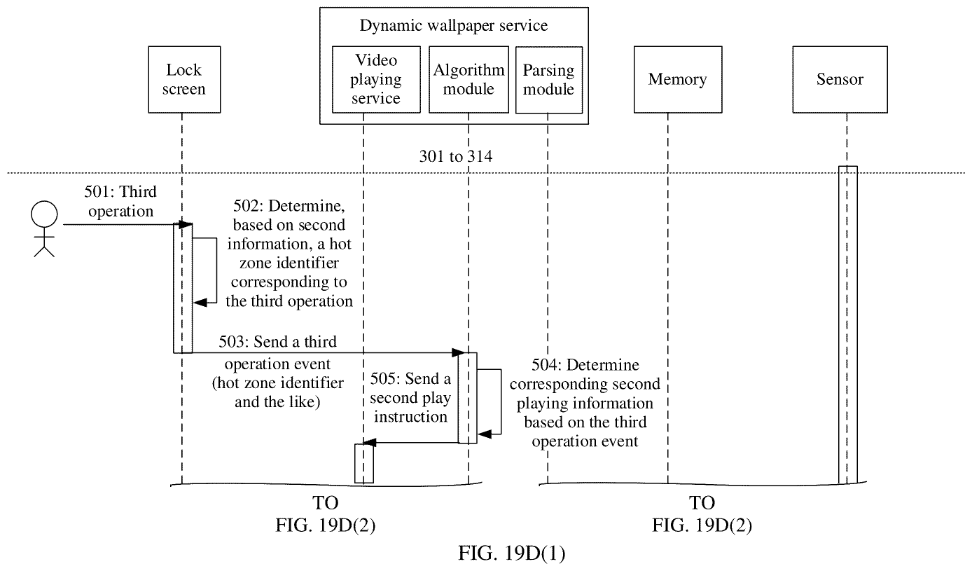

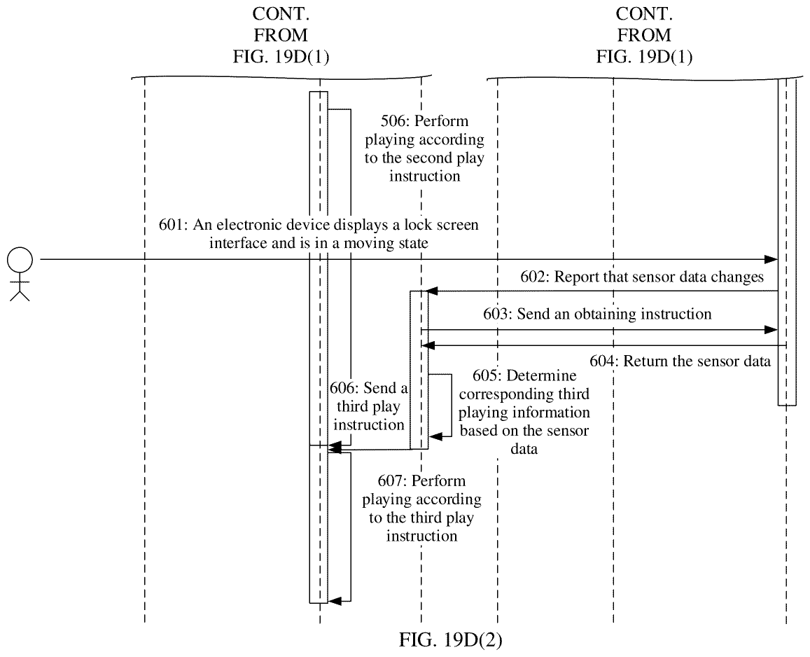

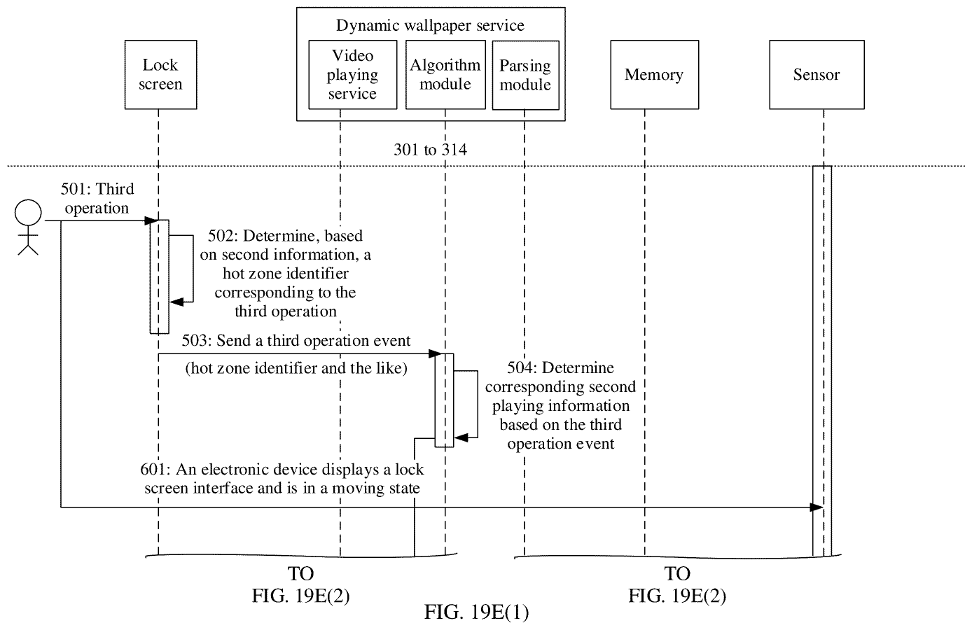

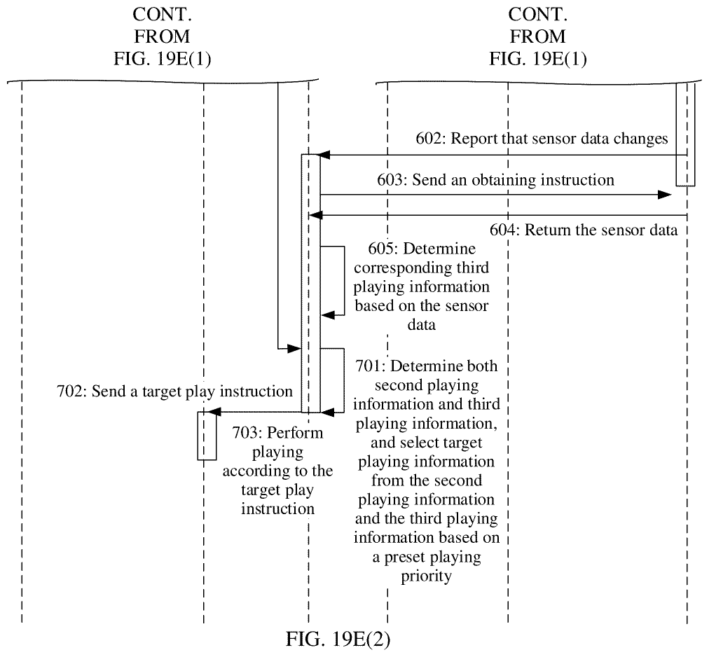

FIG. 19A(1) to FIG. 19D(2) are schematic flowcharts of another method for displaying a dynamic wallpaper according to an embodiment of this application.

When a hot zone is configured and gravity sensing is configured for a target theme, the method 700 may include step S301 to step S314 shown in FIG. 7A and FIG. 7B, step S501 to step S504, and step S601 to step S607.

An electronic device may perform S301 to S304 during booting or theme switching. For S301 to S314, refer to the foregoing description of FIG. 7A and FIG. 7B.

In an embodiment, when a hot zone is configured and gravity sensing is configured, the electronic device may perform S601 to S607 when the electronic device does not receive a user operation for the hot zone, displays only a lock screen interface, and is in a moving state. For S601 to S607, refer to the foregoing description of FIG. 15A and FIG. 15B. Details are not described herein again. In other words, in this embodiment of this application, even if the hot zone is configured, when no tap operation for the hot zone is received, the electronic device plays a corresponding video section based on a detected gravity sensing type.

In another embodiment, when the hot zone is configured and gravity sensing is configured, the electronic device displays a lock screen interface and is in a non-moving state (or referred to as a static state). When receiving a tap operation for the hot zone, S501 to S506 may be performed. For S501 to S506, refer to the foregoing description of FIG. 11A and FIG. 11B. Details are not described herein again. In other words, in this embodiment of this application, even if gravity sensing is configured and a hot zone is configured, when no change of sensor data is detected and only a tap operation for the hot zone is received, the electronic device plays a corresponding video section based on a determined hot zone identifier.

In still another embodiment, as shown in FIG. 19A(1) and FIG. 19A(2), when a hot zone is configured and gravity sensing is configured, the electronic device displays a lock screen interface and is in a moving state, and may perform S601 to S607. In a process of playing the video section corresponding to the gravity sensing type, if a user operation for the hot zone is received, based on a configured playing rule of not interrupting a currently played video, a second play instruction may not be delivered, and S607 is further performed to play the video section corresponding to the gravity sensing type, until playing of the video section is completed. Alternatively, as shown in FIG. 19B(1) and FIG. 19B(2), based on a configured playing rule of interrupting a currently played video and playing a new video, playing of the video section corresponding to the gravity sensing type may be stopped, and S505 and S506 are performed to play a video section corresponding to a hot zone.

To be specific, in this embodiment of this application, when the electronic device receives the tap operation for the hot zone in a process of playing a corresponding video section based on a detected gravity sensing type, the electronic device may continue playing the video section corresponding to the gravity sensing type; or may stop playing the video section corresponding to the gravity sensing type, and switch to playing the video section corresponding to the hot zone.

In still another embodiment, as shown in FIG. 19C(1) and FIG. 19C(2), when a hot zone is configured and gravity sensing is configured, the electronic device displays a lock screen interface and is in a non-moving state, and may perform S501 to S506 when receiving a hot-zone tap operation. In a process of playing the video section corresponding to the hot zone, if it is detected that the electronic device is in the moving state and the sensor data changes, a third play instruction may not be delivered according to a configured playing rule of not interrupting a currently played video. S506 is further performed to play the video section corresponding to the hot zone, until playing of the video section is completed. Alternatively, as shown in FIG. 19D(1) and FIG. 19D(2), based on a configured playing rule of interrupting a currently played video and playing a new video, playing of the video section corresponding to the hot zone may be stopped, and S606 and S607 are performed to play a video section corresponding to a gravity sensing type.

To be specific, in this embodiment of this application, in a process in which the electronic device plays the corresponding video section based on the determined hot zone identifier, when gravity sensing is detected, the electronic device may continue playing the video section corresponding to the hot zone, or may stop playing the video section corresponding to the hot zone, and switch to play the video section corresponding to the gravity sensing type.

In still another embodiment, as shown in FIG. 19E (1) and FIG. 19E (2), when a hot zone is configured and gravity sensing is configured, the electronic device displays the lock screen interface. When the electronic device receives both a hot-zone tap operation event and a sensor data change reported by a sensor, step S701 to step S703 below may be performed.

S701: When determining both second playing information and third playing information, a dynamic wallpaper service selects target playing information from the second playing information and the third playing information based on a preset playing priority.

Optionally, after determining second playing information adapted to a hot zone identifier, a first video adaptation module in an algorithm module may send the second playing information to a video selection algorithm module; and after determining third playing information adapted to the sensor data, a second video adaptation module in the algorithm module may send the third playing information to the video selection algorithm module. Then, the video selection algorithm module may select, from the second playing information and the third playing information based on the preset playing priority, information that needs to be actually played subsequently.

For example, it may be preset that a priority of the second playing information is higher than a priority of the third playing information. In other words, a priority of playing a video section corresponding to a hot zone is higher than that of playing a video section corresponding to a gravity sensing type.

S702: The algorithm module in the dynamic wallpaper service sends a target play instruction to a video playing service module.

The target play instruction instructs to play a corresponding video frame interval based on a determined video section identifier in the target playing information. The target play instruction carries a video section identifier selected based on the second playing information and the third playing information.

S703: The video playing service module performs playing according to a third play instruction.

For example, if a user shakes the electronic device when the user currently taps the hot zone, in this case, the first video adaptation module may determine the second play information based on the tap event and send the second playing information to the video selection algorithm module, and the second video adaptation module may determine the third playing information based on the sensor data and send the third playing information to the video selection algorithm module. After receiving the second playing information and the third playing information, the video selection algorithm module performs screening based on a preset playing priority (for example, the second playing information has a higher priority than the third playing information), to instruct the video playback service to play a video based on a video frame interval indicated by the second playing information.

The foregoing is the example of displaying a dynamic wallpaper after a hot zone is tapped and an electronic device is in a moving state when a hot zone is configured and gravity sensing is configured.

FIG. 20 and FIG. 21 are diagrams of related interfaces of setting to stay lock-screen after an outer screen is unlocked according to an embodiment of this application.

As shown in (a) in FIG. 20, an electronic device may detect a tap operation performed by a user on a settings application on a home screen. In response to the tap operation on the settings application, the electronic device may switch to and display a main interface of the settings application, as shown in (b) in FIG. 20. The main interface of the settings application includes a search bar, and a plurality of options such as WLAN, Bluetooth, More connections, Foldable screen, Home screens and personal settings, and Display and brightness. The electronic device may receive a tap operation of the user for the Foldable screen option, as shown in (b) in FIG. 20. In response to the tap operation for the Foldable screen option, the electronic device may switch from the main interface to a Foldable screen interface shown in (a) in FIG. 21.

In the Foldable screen interface shown in (a) in FIG. 21, setting options for a home screen, a lock screen, and always-on display are displayed. For example, for the home screen, two setting options: a home screen application and a home screen widget; and for the lock screen and always-on display, a “Stay lock-screen after the outer screen is unlocked” switch option and an always-on display on the outer screen setting option are included.

In the Foldable screen interface shown in (a) in FIG. 21, the “Stay lock-screen after the outer screen is unlocked” switch option is in an off state. Correspondingly, the outer screen of the electronic device may be switched from a screen-off interface or an always-on display interface to the lock screen interface shown in (b) in FIG. 4; and then, in response to an unlocking operation of the user, the outer screen of the electronic device switches from the lock screen interface shown in (b) in FIG. 4 to the home screen shown in (d) in FIG. 4.

In the Foldable screen interface shown in (a) in FIG. 21, in response to a tap operation or a slide operation of the user, the “Stay lock-screen after the outer screen is unlocked” switch option is switched from the off state to an on state, as shown in (b) in FIG. 21. Correspondingly, the outer screen of the electronic device may be switched from the screen-off interface or the always-on display interface to the lock screen interface shown in (b) in FIG. 4. Then, in response to an unlock operation of the user, the outer screen of the electronic device stays in the lock screen interface shown in (c) in FIG. 4 from the lock screen interface shown in (b) in FIG. 4. Subsequently, after receiving a slide operation of the user, the user switches from the lock screen interface shown in (c) in FIG. 4 to the home screen shown in (d) in FIG. 4.

The foregoing is an example of setting to stay lock-screen after an outer screen is unlocked according to an embodiment of this application.

FIG. 22A, FIG. 22B, FIG. 22C, FIG. 22D, FIG. 23A, and FIG. 23B are diagrams of related interfaces of switching a lock screen theme according to an embodiment of this application.

In response to a tap operation for the Foldable screen in a set main interface, the electronic device may display the Foldable screen interface shown in FIG. 22A. The foldable screen interface is the same as the interface shown in (b) in FIG. 21. The foldable screen interface includes a Change the pattern control.

The electronic device may receive a tap operation for the Change the pattern control, as shown in FIG. 22A. In response to the tap operation, the electronic device may switch to the Change the pattern interface shown in FIG. 22B. An upper half display region of the Change the pattern interface includes a historical pattern that has been used by a user, that is, “My pattern”. The historical pattern includes a theme currently used by the outer screen and a previously used theme. A lower half display region of the Change the pattern interface further includes theme icons of a plurality of preset themes, for example, theme icons of two themes in a cute pets type.

On this basis, the electronic device may receive a tap operation for a first theme icon, as shown in FIG. 22C. In response to the tap operation, the electronic device may display a preview interface of a theme indicated by the first theme icon, as shown in FIG. 22D. An upper half region of the preview interface is used to display previewed theme content, and a lower half region of the preview interface displays theme icons corresponding to the two themes in the cute pets type. In this case, the first theme icon is in a selected state. For example, a border becomes thicker.

As shown in FIG. 22D, an upper right corner of the preview interface further includes an application control. The electronic device may detect a tap operation for the application control, as shown in FIG. 23A. In response to a tap operation for the application control, the previewed theme content may be applied to a lock screen interface of the outer screen.

The foregoing is an example of switching a lock screen theme of an outer screen according to an embodiment of this application.

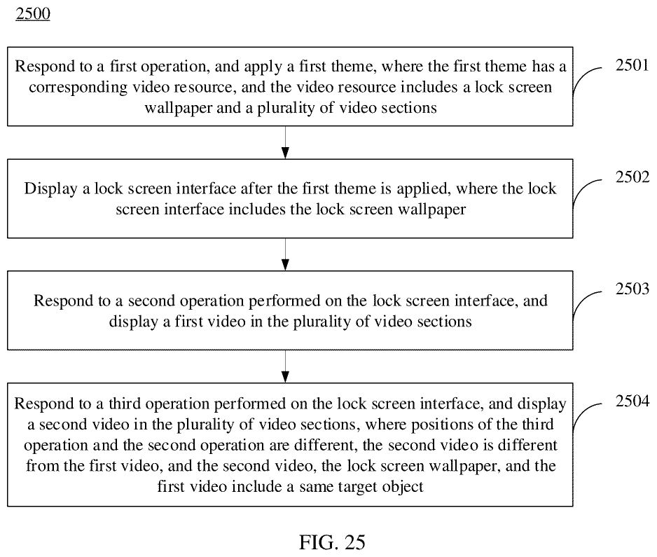

FIG. 25 is a schematic flowchart of a method for displaying a dynamic wallpaper according to an embodiment of this application.

As shown in FIG. 25, the method 2500 may include steps S2501 to S2504. The following describes step S2501 to step S2504 in detail.

S2501: Respond to a first operation, and apply a first theme, where the first theme has a corresponding video resource, and the video resource includes a lock screen wallpaper and a plurality of video sections.

The first operation may be a tap operation, or certainly may be another operation.

As shown in FIG. 23A and FIG. 23B, the first operation may be a tap operation on an application control included in an interface shown in FIG. 24A. The first theme may be preview content included in the interface shown in FIG. 24A. In response to the first operation on the application control, the electronic device may apply the first theme.

It should be noted that the applied theme and the method for displaying a dynamic wallpaper for playing a plurality of video sections provided in this embodiment of this application are implemented by code.

S2502: Display a lock screen interface after the first theme is applied, where the lock screen interface includes the lock screen wallpaper.

In this embodiment of this application, the lock screen interface may be interfaces shown in (b) in FIG. 4 and (c) in FIG. 4.

S2503: Respond to a second operation performed on the lock screen interface, and display a first video in the plurality of video sections.

The second operation may be a tap operation, or certainly may be another operation.

S2504: Respond to a third operation performed on the lock screen interface, and display a second video in the plurality of video sections, where positions of the third operation and the second operation are different, the second video is different from the first video, and the second video, the lock screen wallpaper, and the first video include a same target object. This application implements rich dynamic-wallpaper display effect during user interaction, thereby improving user experience.

The third operation may be a tap operation, or certainly may be another operation.

For example, the target object may be a kitten shown in FIG. 12. For example, if a first tap operation is performed on the lock screen interface, a first video section related to the kitten may be played; and if a second tap operation is performed on the lock screen interface, a second video section related to the same kitten may be played. The kitten has different actions in the first video section and the second video section.

In this embodiment of this application, a user performs two operations at different positions on the lock screen interface, to trigger the electronic device to play two different video sections related to a same target object, thereby implementing rich display effect and increasing interest of using the electronic device.

It should be understood that positions of the third operation and the second operation may be different, or may be the same. This is equivalent to the user performing an operation at the same position twice, but playing different videos.

It should be understood that the foregoing descriptions by using examples are intended to help a person skilled in the art understand embodiments of this application, but are not intended to limit embodiments of this application to specific values or specific scenarios illustrated. Apparently, a person skilled in the art can make various equivalent modifications or changes based on the foregoing descriptions of the examples, and such modifications or changes also fall within the scope of embodiments of this application.

Optionally, this application further provides a computer program product. When the computer program product is executed by the processor, the method for displaying a dynamic wallpaper according to any method embodiment of this application is implemented.

For example, the computer program product may be stored in a memory, such as a program, and the program is finally converted, by performing processing processes such as preprocessing, compiling, assembling, and linking, into an executable target file that can be executed by the processor.

Optionally, this application further provides a computer-readable storage medium, and the computer-readable storage medium stores a computer program. When the computer program is executed by a computer, the method for displaying a dynamic wallpaper according to any method embodiment of this application is implemented. The computer program may be a program in an advanced language or an executable target program.

For example, the computer-readable storage medium is the memory. The memory may be a volatile memory or a non-volatile memory. Alternatively, the memory may include both a volatile memory and a non-volatile memory. The non-volatile memory may be a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (random access memory, RAM) and is used as an external cache. Through example but not limitative description, many forms of RAMs may be used, for example, a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus dynamic random access memory (direct rambus RAM, DR RAM).

A person of ordinary skill in the art may be aware that, with reference to the examples described in embodiments disclosed in this specification, units and algorithm steps may be implemented by electronic hardware or a combination of computer software and electronic hardware. Whether these functions are performed by hardware or software depends on specific applications and design constraints of the technical solutions. A person skilled in the art may use different methods to implement the described functions for each specific application, but it should not be considered that such an implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In several embodiments provided in this application, it should be understood that the disclosed system, apparatus, and method may be implemented in other manners. For example, the embodiments of the electronic device described above are merely examples. For example, division into the modules is merely logical function division and there may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or the units may be implemented in an electrical form, a mechanical form, or another form.

The units described as separate parts may or may not be physically separate, and parts displayed as units may or may not be physical units, may be located in one position, or may be distributed on a plurality of network units. A part or all of the units may be selected based on actual requirements to achieve the objectives of the solutions in embodiments.

In addition, the functional units in embodiments of this application may be integrated into one processing unit, or each unit may exist alone physically, or two or more units may be integrated into one unit.

It should be understood that sequence numbers of the processes do not mean execution orders in various embodiments of this application. The execution orders of the processes should be determined based on functions and internal logic of the processes, and should not be constituted as any limitation on the implementation processes of embodiments of this application.

In addition, the term “and/or” in this specification describes only an association relationship between associated objects and indicates that three relationships may exist. For example, A and/or B may represent the following three cases: Only A exists, both A and B exist, and only B exists. In addition, the character “/” in this specification generally represents an “or” relationship between the associated objects.

When the function is implemented in a form of a software functional unit and sold or used as an independent product, the function may be stored in a computer-readable storage medium. Based on such an understanding, the technical solutions of this application essentially, or the part contributing to the conventional technology, or some of the technical solutions may be implemented in a form of a software product. The computer software product is stored in a storage medium, and includes several instructions for instructing a computer device (which may be a personal computer, a server, a network device, or the like) to perform all or some of the steps of the methods described in embodiments of this application. The foregoing storage medium includes any medium that can store program code, such as a USB flash drive, a removable hard disk drive, a read-only memory (read-only memory, ROM), a random access memory (random access memory, RAM), a magnetic disk, or an optical disc.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims. In conclusion, the foregoing embodiments are merely preferred embodiments of the technical solutions of this application, and are not used to limit the protection scope of this application. Any modification, equivalent substitution, improvement, and the like made within the spirit and the principle of this application shall be included in the protection scope of this application.

What is claimed is:

1. A method for displaying a dynamic wallpaper, applied to an electronic device, wherein the electronic device is a foldable device, the foldable device comprises a first display and a second display, the first display is larger than the second display, the first display is foldable, the second display is unfoldable, and the method comprises:
after a first lock screen wallpaper is applied to the second display, displaying a first lock screen interface on the second display, wherein the first lock screen wallpaper comprises a plurality of video sections, and the plurality of video sections each comprise a first target object;
receiving a first operation performed on the first lock screen interface;
determining, based on a position of the first operation on the second display, a touch region in which the first operation is located;
when the position of the first operation belongs to a first touch region, obtaining, based on a region identifier of the first touch region, a video identifier of a first video corresponding to the first touch region in the plurality of video sections, and determining the first video based on the video identifier of the first video, wherein the first video is displayed on the second display, and the video identifier of the first video comprises at least the region identifier of the first touch region; and
when the position of the first operation belongs to a second touch region, obtaining, based on a region identifier of the second touch region, a video identifier of a second video corresponding to the second touch region in the plurality of video sections, and determining the second video based on the video identifier of the second video, wherein the second video is displayed on the second display, and the video identifier of the second video comprises at least the region identifier of the second touch region; and
the first touch region is different from the second touch region, and the first video is different from the second video.

2. The method according to claim 1, wherein after determining the first video based on the video identifier of the first video, the method further comprises:
receiving a second operation;
determining, based on a position of the second operation, a touch region in which the second operation is located; and
when the position of the second operation belongs to the first touch region, displaying a third video corresponding to the first touch region in the plurality of video sections, wherein the third video is the same as or different from the first video, and the third video is different from the second video.

3. The method according to claim 1, wherein the first touch region and the second touch region further meet any one or more of the following conditions:
the first touch region and the second touch region fill a full-screen region of the second display;
both the first touch region and the second touch region are in irregular shapes; and
sizes of the first touch region and the second touch region are different.

4. The method according to claim 1, wherein the method further comprises:
applying a second lock screen wallpaper to the first display, wherein the second lock screen wallpaper comprises a plurality of video sections, and the plurality of video sections in the second lock screen wallpaper each comprise a second target object but do not comprise the first target object;
displaying a second lock screen interface after the second lock screen wallpaper is applied to the second display;
receiving, on the second lock screen interface, a third operation performed in any position of the second display; and
in response to the third operation, displaying one video section in the plurality of video sections in the second lock screen wallpaper according to a preset sequence.

5. The method according to claim 1, wherein setting the first lock screen wallpaper on the first display for the second display comprises:
displaying a setting interface on the first display, wherein the setting interface comprises a first control, and the first control is used to set the second display of the electronic device;
displaying preview images of a plurality of to-be-selected lock screen wallpapers in response to a selection operation on the first control, wherein the preview images of the plurality of to-be-selected lock screen wallpapers comprise a preview image of the first lock screen wallpaper; and
after the preview image of the first lock screen wallpaper is selected, applying the first lock screen wallpaper to the second display.

6. The method according to claim 1, wherein the first touch region has a corresponding first coordinate range, the second touch region has a corresponding second coordinate range, and determining, based on the position of the first operation, the touch region in which the first operation is located comprises:
obtaining first coordinates of the position of the first operation; and
when the first coordinates belong to the first coordinate range, determining, as the first touch region, a region in which the first operation is located; or
when the first coordinates belong to the second coordinate range, determining, as the second touch region, a region in which the first operation is located.

7. The method according to claim 1, wherein a plurality of local regions of the first target object comprised in the first lock screen wallpaper correspond to a same touch region.

8. The method according to claim 1, wherein the electronic device comprises a first camera and a second camera, the first camera, the second camera, and the second display are disposed on a same side of a hinge of the electronic device, both the first camera and the second camera are arranged close to a long side of the unfolded electronic device, the first camera and the second camera are not under display cameras, the second display comprises a first display region and a second display region, the first display region surrounds the first camera and the second camera, the first display region does not comprise a region in which the first camera and the second camera are located, and the first display region and the second display region are arranged in a direction of a short side of the unfolded electronic device.

9. The method according to claim 8, wherein the first display region has at least an overlapping region with the first touch region or the second touch region, the second display region has at least an overlapping region with the first touch region or the second touch region, and the method further comprises:
displaying an interface of a desktop application on the second display, wherein the interface of the desktop application comprises a widget and a plurality of application icons, the widget is displayed in the first display region, and the application icons are displayed in the second display region; and
in response to a trigger operation on an icon of a first application in the plurality of application icons, switching, in the second display region, from displaying the application icons to displaying an application interface of the first application, wherein the first display region continues displaying the widget.

10. The method according to claim 9, wherein the method further comprises:
in response to a trigger operation on an icon of a second application in the plurality of application icons, displaying an application interface of the second application in a full-screen region of the second display.

11. The method according to claim 9, wherein the widget comprises one or more of the following: weather information, exercise information, health information, date, and a clock indicator.

12. The method according to claim 1, wherein the electronic device is a vertically folding device or a horizontally folding device.

13. The method according to claim 1, wherein after the displaying the first lock screen interface, the method further comprises:
responding to a first action of the electronic device, and displaying a fourth video in the plurality of video sections of the first lock screen wallpaper; and
responding to a second action of the electronic device, and displaying a fifth video in the plurality of video sections of the first lock screen wallpaper, wherein the first action is different from the second action, the fifth video is different from the fourth video, and both the fourth video and the fifth video comprise the first target object.

14. The method according to claim 13, wherein after the responding to a first action of the electronic device, the method further comprises:
determining that a gravity sensing type corresponding to the first action of the electronic device is a first gravity sensing type; and
determining, from the plurality of video sections of the first lock screen wallpaper, the fourth video corresponding to the first gravity sensing type.

15. The method according to claim 14, wherein the electronic device comprises a sensor; and the determining that a gravity sensing type corresponding to the first action of the electronic device is a first gravity sensing type comprises:
determining first sensor data corresponding to the first action of the electronic device; and
determining that the first sensor data belongs to a sensor data range of the first gravity sensing type, and determining that the gravity sensing type corresponding to the first action of the electronic device is the first gravity sensing type.

16. The method according to claim 14, wherein the gravity sensing type comprises: at least one of tilting to the left, tilting to the right, shaking up to the left, shaking up to the right, shaking down to the left, shaking down to the right, moving forward in a direction perpendicular to a screen, or moving backward in a direction perpendicular to a screen.

17. The method according to claim 1, wherein the first operation is a tap operation.

18. The method according to claim 1, wherein the first lock screen interface comprises: an interface displayed by the electronic device when a screen is turned on and locked, and an interface displayed when a home screen is not displayed after the screen is turned on and unlocked.

19. An electronic device, comprising:
one or more processors;
one or more memories; and
a module at which a plurality of applications are installed, wherein
the memory stores one or more programs, and when the one or more programs are executed by the processors, the electronic device is enabled to perform the following steps:
after a first lock screen wallpaper is applied to a second display, displaying a first lock screen interface on the second display, wherein the first lock screen wallpaper comprises a plurality of video sections, and the plurality of video sections each comprise a first target object;
receiving a first operation performed on the first lock screen interface;
determining, based on a position of the first operation on the second display, a touch region in which the first operation is located;
when the position of the first operation belongs to a first touch region, obtaining, based on a region identifier of the first touch region, a video identifier of a first video corresponding to the first touch region in the plurality of video sections, and determining the first video based on the video identifier of the first video, wherein the first video is displayed on the second display, and the video identifier of the first video comprises at least the region identifier of the first touch region; and
when the position of the first operation belongs to a second touch region, obtaining, based on a region identifier of the second touch region, a video identifier of a second video corresponding to the second touch region in the plurality of video sections, and determining the second video based on the video identifier of the second video, wherein the second video is displayed on the second display, and the video identifier of the second video comprises at least the region identifier of the second touch region; and
the first touch region is different from the second touch region, and the first video is different from the second video.

20. A non-transitory computer storage medium, comprising:
a computer program, which when executed by a processor, cause the processor to perform operations comprising:
after a first lock screen wallpaper is applied to a second display, displaying a first lock screen interface on the second display, wherein the first lock screen wallpaper comprises a plurality of video sections, and the plurality of video sections each comprise a first target object;
receiving a first operation performed on the first lock screen interface;
determining, based on a position of the first operation on the second display, a touch region in which the first operation is located;
when the position of the first operation belongs to a first touch region, obtaining, based on a region identifier of the first touch region, a video identifier of a first video corresponding to the first touch region in the plurality of video sections, and determining the first video based on the video identifier of the first video, wherein the first video is displayed on the second display, and the video identifier of the first video comprises at least the region identifier of the first touch region; and
when the position of the first operation belongs to a second touch region, obtaining, based on a region identifier of the second touch region, a video identifier of a second video corresponding to the second touch region in the plurality of video sections, and determining the second video based on the video identifier of the second video, wherein the second video is displayed on the second display, and the video identifier of the second video comprises at least the region identifier of the second touch region; and
the first touch region is different from the second touch region, and the first video is different from the second video.
